(19) United States
(12) Patent Application Publication
(10) Pub. No.: US 2024/0277197 A1
(43) Pub. Date: Aug. 22, 2024

(54) CLEANER STATION AND CLEANER SYSTEM

(71) Applicant: LG Electronics Inc., Seoul (KR)

(72) Inventors: Jaewon JANG, Seoul (KR); Sangik LEE, Seoul (KR); Kietak HYUN, Seoul (KR); Hyunsup SONG, Seoul (KR)

(21) Appl. No.: 18/571,603

(22) PCT Filed: Jun. 16, 2022
(86) PCT No.: PCT/KR2022/008546

§ 371 Date: Dec. 18, 2023

(30) Foreign Application Priority Data
Jun. 16, 2021 (KR) 10-2021-0078249

(51) Int. Cl. A47L 9/16; A47L 5/28

(52) U.S. Cl. CPC A47L 9/1683; A47L 5/28; A47L 9/1608

(57) ABSTRACT

The present disclosure relates to a cleaner station, the cleaner station including a door unit including a door hingedly coupled to a coupling surface and configured to open or close a dust passage hole formed in the coupling surface, and a flow path part provided in a flow path tube and configured to connect a dust bin of the cleaner and a dust collecting part, in which the door unit includes a scraper coupled to the door and configured to come into contact with at least a part of the flow path tube when the door blocks the dust passage hole, and the scraper wipes away foreign substances in a flow path when the door rotates, thereby removing dirt remaining in the dust bin, remaining at the periphery of a coupling part, or remaining in the flow path.

### TECHNICAL FIELD

The present disclosure relates to a cleaner station and a cleaner system, and more particularly, to a cleaner station and a cleaner system, which are capable of sucking dust, which is stored in a cleaner, into the cleaner station and removing foreign substances remaining at the periphery of a cleaner door.

### BACKGROUND ART

In general, a cleaner refers to an electrical appliance that draws in small garbage or dust by sucking air using electricity and fills a dust bin provided in a product with the garbage or dust. Such a cleaner is generally called a vacuum cleaner.

The cleaners may be classified into a manual cleaner which is moved directly by a user to perform a cleaning operation, and an automatic cleaner which performs a cleaning operation while autonomously traveling. Depending on the shape of the cleaner, the manual cleaners may be classified into a canister cleaner, an upright cleaner, a handy cleaner, a stick cleaner, and the like.

The canister cleaners were widely used in the past as household cleaners. However, recently, there is an increasing tendency to use the handy cleaner and the stick cleaner in which a dust bin and a cleaner main body are integrally provided to improve convenience of use.

In the case of the canister cleaner, a main body and a suction port are connected by a rubber hose or pipe, and in some instances, the canister cleaner may be used in a state in which a brush is fitted into the suction port.

The handy cleaner (hand vacuum cleaner) has maximized portability and is light in weight. However, because the handy cleaner has a short length, there may be a limitation to a cleaning region. Therefore, the handy cleaner is used to clean a local place such as a desk, a sofa, or an interior of a vehicle.

A user may use the stick cleaner while standing and thus may perform a cleaning operation without bending his/her waist. Therefore, the stick cleaner is advantageous for the user to clean a wide region while moving in the region. The handy cleaner may be used to clean a narrow space, whereas the stick cleaner may be used to clean a wide space and also used to a high place that the user's hand cannot reach. Recently, modularized stick cleaners are provided, such that types of cleaners are actively changed and used to clean various places.

In addition, recently, a robot cleaner, which autonomously performs a cleaning operation without a user's manipulation, is used. The robot cleaner automatically cleans a zone to be cleaned by sucking foreign substances such as dust from the floor while autonomously traveling in the zone to be cleaned.

However, because the handy cleaner, the stick cleaner, or the robot cleaner in the related art has a dust bin with a small capacity for storing collected dust, which inconveniences the user because the user needs to empty the dust bin frequently.

In addition, because the dust scatters during the process of emptying the dust bin, there is a problem in that the scattering dust has a harmful effect on the user's health.

In addition, if residual dust is not removed from the dust bin, there is a problem in that a suction force of the cleaner deteriorates.

In addition, if the residual dust is not removed from the dust bin, there is a problem in that the residual dust causes an offensive odor.

As a document of the related art, Korean Patent Application Laid-Open No. 10-2020-0074001 discloses a cleaning apparatus including a vacuum cleaner and a docking station.

The cleaning apparatus disclosed in Korean Patent Application Laid-Open No. 10-2020-0074001 includes the vacuum cleaner including a dust collecting container for collecting foreign substances, and the docking station connected to the dust collecting container and configured to remove the foreign substances collected in the dust collecting container. The dust collecting container is configured to be docked to the docking station, and the docking station includes a suction device configured to suck foreign substances and inside air in the dust collecting container docked to the docking station.

In addition, Korean Patent Application Laid-Open No. 10-2020-0074001 includes a trapping part disposed in the docking station and configured to trap foreign substances.

However, according to Korean Patent Application Laid-Open No. 10-2020-0074001, there is a problem in that after stopping the suction operation, the suction device (a suction fan) cannot remove foreign substances remaining at the periphery of a seating portion, to which the dust collecting container is coupled, and remaining in a suction flow path through which foreign substances are sucked.

For this reason, a user experiences the inconvenience of having to manually remove residual dust with wet wipes or the like after the process of sucking foreign substances ends.

In addition, the foreign substances may be accumulated in the docking station, which contaminates the interior of the docking station.

### DISCLOSURE

### Technical Problem

The present disclosure has been made in an effort to solve the above-mentioned problem with a cleaner station, a cleaner system, and a method of controlling the same in the related art, and an object of the present disclosure is to provide a cleaner station capable of removing dirt remaining in a dust bin, a coupling part, or a flow path part even after dust in the dust bin is collected.

Another object of the present disclosure is to provide a cleaner station capable of providing convenience for a user by enabling the user to remove dust in a dust bin without a separate manipulation.

Still another object of the present disclosure is to provide a cleaner station capable of preventing hairs and the like from being tangled in a dust bin, a coupling part, or a flow path part.

Yet another object of the present disclosure is to provide a cleaner station capable of preventing foreign substances from remaining in a flow path, which causes a loss of a suction force.

### Technical Solution

In order to achieve the above-mentioned objects, the present disclosure provides a cleaner station including: a housing; a coupling part disposed in the housing and including a coupling surface to which at least a part of a cleaner is coupled; a dust collecting part accommodated in the housing, disposed below the coupling part, and configured to capture dust in a dust bin of the cleaner; a dust collecting motor accommodated in the housing, disposed below the dust collecting part, and configured to generate a suction force for sucking the dust in the dust bin; a door unit including a door hingedly coupled to the coupling surface to open or close a dust passage hole formed in the coupling surface; and a flow path part provided in a flow path tube disposed in the housing, the flow path part being configured to connect the dust bin of the cleaner and the dust collecting part.

In this case, the door unit may include a scraper coupled to the door and configured to come into contact with at least a part of the flow path tube when the door blocks the dust passage hole.

The door may include: a first door hingedly coupled to the coupling surface; and a second door hingedly coupled to the first door, and the scraper may be coupled to the second door and protrude downward from the second door.

The second door may include: a second door main body hingedly coupled to the first door; and a second door outer wall surface formed at an outer end of the second door main body and configured to face a sidewall of the dust passage hole when the door blocks the dust passage hole, and the scraper may be coupled to the second door outer wall surface and protrude outward from the second door outer wall surface.

The scraper may include: a door coupling part coupled to an outer peripheral surface of the door; a first scraper protruding and extending outward from the door coupling part; and a second scraper protruding from the door coupling part in parallel with the first scraper.

In this case, the scraper may further include a blade provided between the first scraper and the second scraper.

The second scraper may include a plurality of scraper teeth protruding and disposed in parallel at predetermined intervals along the outer peripheral surface of the door.

The scraper may be a squeegee made of a rubber material.

The scraper may be a hollow gasket.

The scraper may include: a door coupling part coupled to an outer peripheral surface of the door; a friction part configured to rub against the flow path tube when the door blocks the dust passage hole; and a connection part configured to connect the door coupling part and the friction part and define a space therein.

The scraper may be made of a felt material.

In addition, the scraper may include a brush.

The flow path part may include: a first flow path configured to communicate with an internal space of the dust bin when the dust passage hole is opened; and a second flow path formed at a predetermined angle with respect to the first flow path and configured to allow the first flow path and an internal space of the dust collecting part to communicate with each other, and the scraper may come into contact with at least a part of a first flow path tube, which constitutes the first flow path, when the door blocks the dust passage hole.

The flow path part may include: a first flow path penetrated by a longitudinal axis of the dust bin in a state in which the cleaner is coupled to the cleaner station; and a second flow path configured to communicate with the first flow path and penetrated by a longitudinal axis of the cleaner station, the longitudinal axis of the dust bin and the longitudinal axis of the cleaner station may intersect each other in the state in which the cleaner is coupled to the cleaner station, and the scraper may come into contact with at least a part of a first flow path tube, which constitutes the first flow path, when the door blocks the dust passage hole.

In order to achieve the above-mentioned objects, the present disclosure provides a cleaner system including: a cleaner including a suction part having a suction flow path through which air flows, a main body having a dust separating part having at least one cyclone part, and a dust bin configured to store dust separated by the dust separating part; and a cleaner station including a dust collecting part configured to capture the dust in the dust bin, a dust collecting motor configured to generate a suction force for sucking the dust in the dust bin into the dust collecting part, and a housing configured to accommodate the dust collecting part and the dust collecting motor in a longitudinal direction, in which a longitudinal axis of the dust bin and a longitudinal axis of the cleaner station intersect each other in a state in which the cleaner is coupled to the cleaner station, and in which a scraper coupled to a door of the cleaner station rubs against at least a part of a flow path tube, which constitutes a flow path part, when the door of the cleaner station is closed.

### Advantageous Effects

According to the cleaner station, the cleaner system, and the method of controlling the same according to the present disclosure described above, the scraper wipes away foreign substances on the flow path when the door rotates, such that it is possible to remove dirt remaining in the dust bin, remaining at the periphery of the coupling part, or remaining in the flow path.

In addition, it is possible to eliminate the inconvenience caused because the user needs to empty the dust bin all the time.

In addition, the blade provided on the scraper may cut foreign substances such as hairs, thereby preventing hairs and the like from being tangled in the dust bin, the coupling part, or the flow path part.

In addition, the scraper may remove foreign substances remaining in the flow path while rubbing against the flow path tube, thereby preventing the occurrence of a loss of suction force.

### DESCRIPTION OF DRAWINGS

FIG. 1 is a perspective view of a cleaner system including a cleaner station and a cleaner according to an embodiment of the present disclosure.

FIG. 2 is a schematic view illustrating a configuration of the cleaner system according to the embodiment of the present disclosure.

FIGS. 3 to 5 are views for explaining the cleaner of the cleaner system according to the embodiment of the present disclosure.

FIG. 6 is a view for explaining a coupling part of the cleaner station according to the embodiment of the present disclosure.

FIG. 7 is an exploded perspective view for explaining a fixing unit of the cleaner station according to the embodiment of the present disclosure.

FIG. 8 is a front view for explaining a door of the cleaner station according to the embodiment of the present disclosure.

FIGS. 9 and 10 are perspective views of FIG. 8 when viewed in another direction.

FIG. 11 is a view for explaining a state in which the door blocks a dust bin and a hole in the cleaner station according to the embodiment of the present disclosure.

FIG. 12 is a view for explaining a state in which the door of the cleaner station according to the embodiment of the present disclosure is opened.

FIG. 13 is a view for explaining a relationship between a first cleaner and a cover opening unit in the cleaner station according to the embodiment of the present disclosure.

FIGS. 14 and 15 are views for explaining a scraper of a cleaner station according to a first embodiment of the present disclosure.

FIG. 16 is a view for explaining a scraper of a cleaner station according to a second embodiment of the present disclosure.

FIG. 17 is a view for explaining a scraper of a cleaner station according to a third embodiment of the present disclosure.

FIG. 18 is a view for explaining a scraper of a cleaner station according to a fourth embodiment of the present disclosure.

FIG. 19 is a block diagram for explaining a control configuration of the cleaner station according to the embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terminology used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

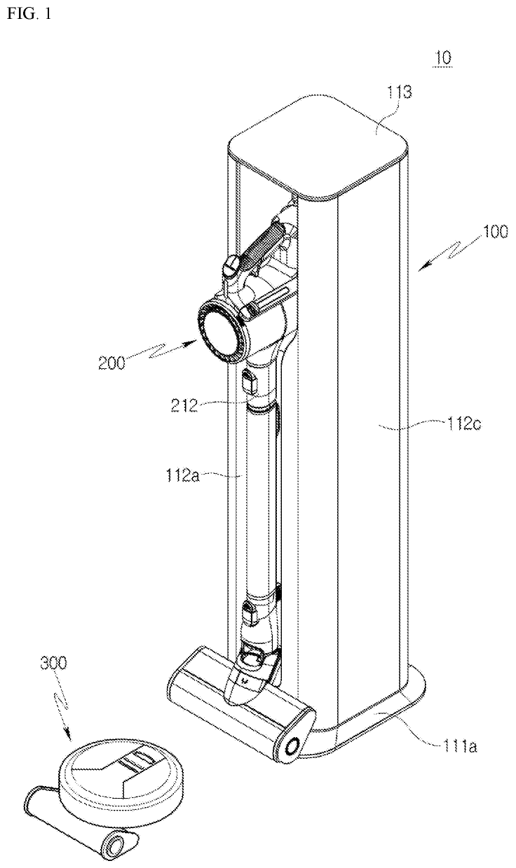

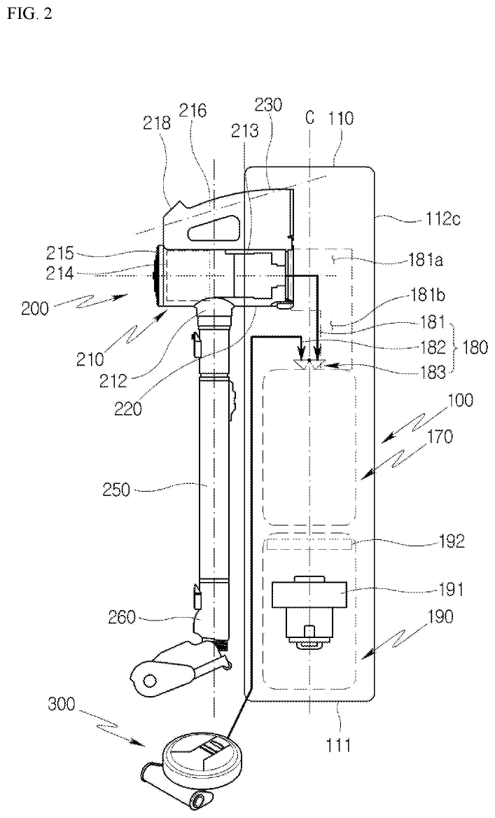

FIG. 1 is a perspective view illustrating a cleaner system including a cleaner station, a first cleaner, and a second cleaner according to an embodiment of the present disclosure, and FIG. 2 is a schematic view illustrating a configuration of the cleaner system according to the embodiment of the present disclosure.

With reference to FIGS. 1 and 2, a cleaner system 10 according to an embodiment of the present specification may include a cleaner station 100 and cleaners 200 and 300. In this case, the cleaners 200 and 300 may include a first cleaner 200 and a second cleaner 300. Meanwhile, the present embodiment may be carried out without some of the above-mentioned components and does not exclude additional components.

The cleaner system 10 may include the cleaner station 100. The first cleaner 200 and the second cleaner 300 may be coupled to the cleaner station 100. The first cleaner 200 may be coupled to a lateral surface of the cleaner station 100. Specifically, a main body of the first cleaner 200 may be coupled to the lateral surface of the cleaner station 100. The second cleaner 300 may be coupled to a lower portion of the cleaner station 100. The cleaner station 100 may remove dust from a dust bin 220 of the first cleaner 200. The cleaner station 100 may remove dust from a dust bin (not illustrated) of the second cleaner 300.

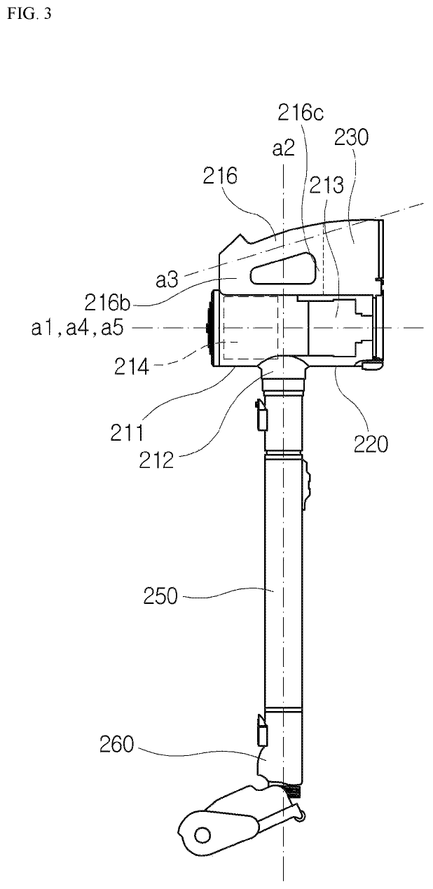

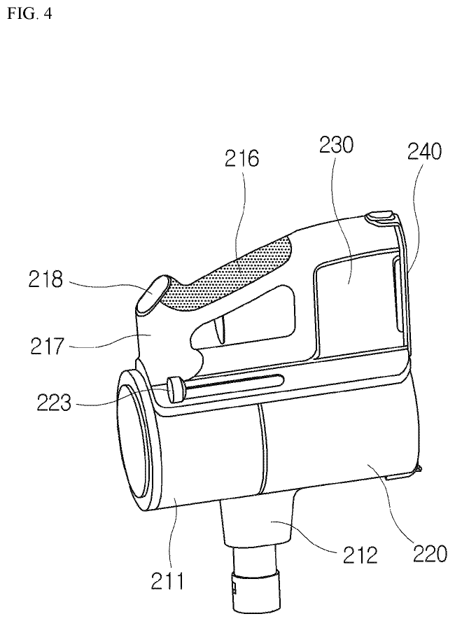

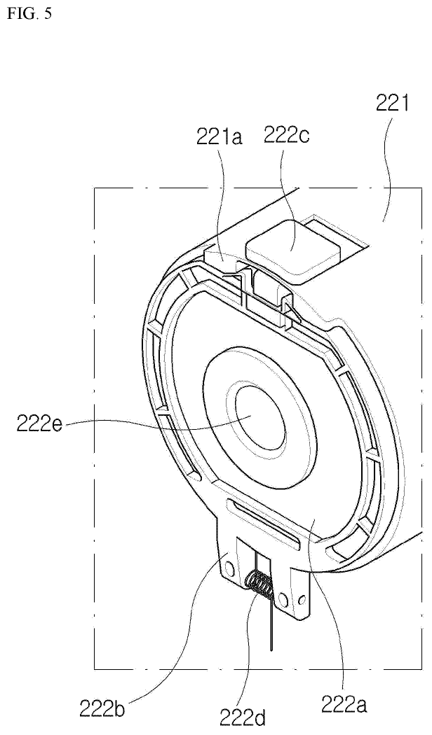

Meanwhile, FIGS. 3 to 5 are views for explaining the first cleaner of the cleaner system according to the embodiment of the present disclosure.

First, a structure of the first cleaner 200 will be described below with reference to FIGS. 1 to 5.

The first cleaner 200 may mean a cleaner configured to be manually operated by a user. For example, the first cleaner 200 may mean a handy cleaner or a stick cleaner.

The first cleaner 200 may be mounted on the cleaner station 100. The first cleaner 200 may be supported by the cleaner station 100. The first cleaner 200 may be coupled to the cleaner station 100.

Meanwhile, in the embodiment of the present disclosure, directions may be defined on the basis of when a bottom surface (lower surface) of the dust bin 220 and a bottom surface (lower surface) of a battery housing 230 are placed on the ground surface.

In this case, a forward direction may mean a direction in which a suction part 212 is disposed on the basis of the suction motor 214, and a rearward direction may mean a direction in which a handle 216 is disposed. Further, on the basis of a state in which the suction part 212 is viewed from the suction motor 214, a rightward direction may refer to a direction in which a component is disposed at the right, and a left direction may refer to a direction in which a component is disposed at the left. In addition, in the embodiment of the present disclosure, upper and lower sides may be defined in a direction perpendicular to the ground surface on the basis of the state in which the bottom surface (lower surface) of the dust bin 220 and the bottom surface (lower surface) of the battery housing 230 are placed on the ground surface.

The first cleaner 200 may include a main body 210. The main body 210 may include a main body housing 211, the suction part 212, a dust separating part 213, the suction motor 214, an air discharge cover 215, the handle 216, and an operating part 218.

The main body housing 211 may define an external appearance of the first cleaner 200. The main body housing 211 may provide a space that may accommodate the suction motor 214 and a filter (not illustrated) therein. The main body housing 211 may be formed in a shape similar to a cylindrical shape.

The suction part 212 may protrude outward from the main body housing 211. For example, the suction part 212 may be formed in a cylindrical shape with an opened inside. The suction part 212 may be coupled to the extension tube 250. The suction part 212 may provide a flow path (hereinafter, referred to as a ‘suction flow path’) through which air containing dust may flow.

Meanwhile, in the present embodiment, an imaginary line may be defined to penetrate the inside of the suction part 212 having a cylindrical shape. That is, an imaginary suction flow path through line a2 may be formed to penetrate the suction flow path in a longitudinal direction.

The dust separating part 213 may communicate with the suction part 212. The dust separating part 213 may separate dust introduced into the dust separating part 213 through the suction part 212. A space in the dust separating part 213 may communicate with a space in the dust bin 220.

For example, the dust separating part 213 may have two or more cyclone parts capable of separating dust using a cyclone flow. Further, the space in the dust separating part 213 may communicate with the suction flow path. Therefore, air and dust, which are introduced through the suction part 212, spirally flow along an inner circumferential surface of the dust separating part 213. Therefore, the cyclone flow may be generated in the internal space of the dust separating part 213.

The dust separating part 213 may communicate with the suction part 212. The dust separating part 213 adopts a principle of a dust collector using a centrifugal force to separate the dust sucked into the main body 210 through the suction part 212.

For example, the dust separating part 213 may include at least one cyclone part capable of separating dust by using a cyclone flow. The cyclone part may communicate with the suction part 212. The air and dust introduced through the suction part 212 spirally flows along an inner peripheral surface of the cyclone part.

The dust separating part 213 may further include a secondary cyclone part configured to separate again dust from the air discharged from the cyclone part. In this case, the secondary cyclone part may be positioned in the cyclone part to minimize a size of the dust separating part. The secondary cyclone part may include a plurality of cyclone bodies disposed in parallel. The air discharged from the cyclone part may be distributed to and pass through the plurality of cyclone bodies.

In this case, an axis of a cyclone flow of the secondary cyclone part may also extend in an upward/downward direction. The axis of the cyclone flow of the cyclone part and the axis of the cyclone flow of the secondary cyclone part may be disposed coaxially in the upward/downward direction and collectively called an axis of the cyclone flow of the dust separating part 213. Meanwhile, in the present embodiment, an imaginary cyclone line a4 may be defined with respect to the axis of the cyclone flow.

The dust separating part 213 may further include a cyclone filter disposed to surround the secondary cyclone part. For example, the cyclone filter is formed in a cylindrical shape and guides the air, which is separated from dust in the cyclone part, to the secondary cyclone part. The cyclone filter may filter out dust while the air pass through the cyclone filter.

To this end, the cyclone filter may include a mesh portion having a plurality of holes. The mesh portion may be made of a metallic material. However, the present disclosure is not limited thereto.

The suction motor 214 may generate a suction force for sucking air. The suction motor 214 may be accommodated in the main body housing 211. The suction motor 214 may generate the suction force while rotating. For example, the suction motor 214 may be formed in a shape similar to a cylindrical shape.

Meanwhile, in the present embodiment, an imaginary suction motor axis a1 may be formed by extending a rotation axis of the suction motor 214.

The air discharge cover 215 may be disposed at one side of the main body housing 211 based on an axial direction. The air discharge cover 215 may accommodate the filter for filtering air. For example, an HEPA filter may be accommodated in the air discharge cover 215.

The air discharge cover 215 may have an air discharge port 215a for discharging the air introduced by the suction force of the suction motor 214.

A flow guide may be disposed on the air discharge cover 215. The flow guide may guide a flow of the air to be discharged through the air discharge port 215a.

The handle 216 may be grasped by a user. The handle 216 may be disposed rearward from the suction motor 214. For example, the handle 216 may be formed in a shape similar to a cylindrical shape. Alternatively, the handle 216 may be formed in a curved cylindrical shape. The handle 216 may be disposed at a predetermined angle with respect to the main body housing 211, the suction motor 214, or the dust separating part 213.

The handle 216 may include a grip portion 216a formed in a column shape so that the user may grasp the grip portion 216a, a first extension portion 216b connected to one end in the longitudinal direction (axial direction) of the grip portion 216a and extending toward the suction motor 214, and a second extension portion 216c connected to the other end in the longitudinal direction (axial direction) of the grip portion 216a and extending toward the dust bin 220.

Meanwhile, in the present embodiment, an imaginary grip portion through line a3 may be formed to extend in the longitudinal direction of the grip portion 216a (the axial direction of the column) and penetrate the grip portion 216a.

For example, the grip portion through line a3 may be an imaginary line formed in the handle 216 having a cylindrical shape, that is, an imaginary line formed in parallel with at least a part of an outer surface (outer circumferential surface) of the grip portion 216a.

An upper side of the handle 216 may define an external appearance of a part of an upper side of the cleaner 200. Therefore, it is possible to prevent a component of the cleaner 200 from coming into contact with the user's arm when the user grasps the handle 216.

The first extension portion 216b may extend from the grip portion 216a toward the main body housing 211 or the suction motor 214. At least a part of the first extension portion 216b may extend in a horizontal direction.

The second extension portion 216c may extend from the grip portion 216a toward the dust bin 220. At least a part of the second extension portion 216c may extend in the horizontal direction.

The operating part 218 may be disposed on the handle 216. The operating part 218 may be disposed on an inclined surface formed in an upper region of the handle 216. The user may input an instruction to operate or stop the first cleaner 200 through the operating part 218.

The first cleaner 200 may include the dust bin 220. The dust bin 220 may communicate with the dust separating part 213. The dust bin 220 may store the dust separated by the dust separating part 213.

The dust bin 220 may include a dust bin main body 221, a discharge cover 222, a dust bin compression lever 223, and a compression member (not illustrated).

The dust bin main body 221 may provide a space capable of storing the dust separated from the dust separating part 213. For example, the dust bin main body 221 may be formed in a shape similar to a cylindrical shape.

Meanwhile, in the present embodiment, an imaginary dust bin through line a5 may be formed to penetrate the inside (internal space) of the dust bin main body 221 and extend in the longitudinal direction of the dust bin main body 221 (that means the axial direction of the cylindrical dust bin main body 221).

A part of a lower side (bottom side) of the dust bin main body 221 may be opened. In addition, a lower extension portion 221a may be formed at the lower side (bottom side) of the dust bin main body 221. The lower extension portion 221a may be formed to block a part of the lower side of the dust bin main body 221.

The dust bin 220 may include the discharge cover 222. The discharge cover 222 may be disposed at a lower side of the dust bin 220.

The discharge cover 222 may be provided to open or close one end of the dust bin main body 221 based on the longitudinal direction. Specifically, the discharge cover 222 may selectively open or close the lower side of the dust bin 220 that is opened downward.

The discharge cover 222 may include a cover main body 222a and a hinge part 222b. The cover main body 222a may be formed to block a part of the lower side of the dust bin main body 221. The cover main body 222a may be rotated downward about the hinge part 222b. The hinge part 222b may be disposed adjacent to the battery housing 230. For example, the hinge part 222b may include a torsion spring 222d. Therefore, when the discharge cover 222 is separated from the dust bin main body 221, an elastic force of the torsion spring 222d may support the cover main body 222a in a state in which the cover main body 222a is rotated by a predetermined angle or more about the hinge part 222b with respect to the dust bin main body 221.

The discharge cover 222 may be coupled to the dust bin 220 by a hook engagement. Meanwhile, the discharge cover 222 may be separated from the dust bin 220 by means of a coupling lever 222c. The coupling lever 222c may be disposed at a front side of the dust bin. Specifically, the coupling lever 222c may be disposed on an outer surface at the front side of the dust bin 220. When an external force is applied, the coupling lever 222c may elastically deform a hook, which extends from the cover main body 222a, in order to release the hook engagement between the cover main body 222a and the dust bin main body 221.

When the discharge cover 222 is closed, the lower side of the dust bin 220 may be blocked (sealed) by the discharge cover 222 and the lower extension portion 221a.

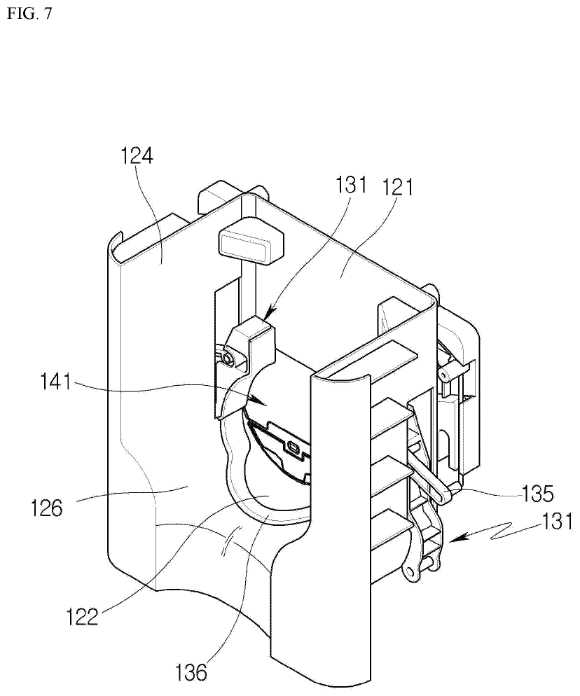

The dust bin 220 may include the dust bin compression lever 223 (see FIG. 7). The dust bin compression lever 223 may be disposed outside the dust bin 220 or the dust separating part 211. The dust bin compression lever 223 may be disposed outside the dust bin 220 or the dust separating part 211 so as to be movable upward and downward. The dust bin compression lever 223 may be connected to the compression member (not illustrated). When the dust bin compression lever 223 is moved downward by external force, the compression member (not illustrated) may also be moved downward. Therefore, it is possible to provide convenience for the user. The compression member (not illustrated) and the dust bin compression lever 223 may return back to original positions by an elastic member (not illustrated). Specifically, when the external force applied to the dust bin compression lever 223 is eliminated, the elastic member may move the dust bin compression lever 223 and the compression member (not illustrated) upward.

The compression member (not illustrated) may be disposed in the dust bin main body 221. The compression member may move in the internal space of the dust bin main body 221. Specifically, the compression member may move upward and downward in the dust bin main body 221. Therefore, the compression member may compress downward the dust in the dust bin main body 221. In addition, when the discharge cover 222 is separated from the dust bin main body 221 and thus the lower side of the dust bin 220 is opened, the compression member may move from an upper side of the dust bin 220 to the lower side of the of the dust bin 220, thereby removing foreign substances such as residual dust in the dust bin 220. Therefore, it is possible to improve the suction force of the cleaner by preventing the residual dust from remaining in the dust bin 220. Further, it is possible to remove an offensive odor caused by the residual dust by preventing the residual dust from remaining in the dust bin 220.

The first cleaner 200 may include the battery housing 230. A battery 240 may be accommodated in the battery housing 230. The battery housing 230 may be disposed at a lower side of the handle 216. For example, the battery housing 230 may have a hexahedral shape opened at a lower side thereof. A rear side of the battery housing 230 may be connected to the handle 216.

The battery housing 230 may include an accommodation portion opened downward. The battery 240 may be attached or detached through the accommodation portion of the battery housing 220.

The first cleaner 200 may include the battery 240.

For example, the battery 240 may be separably coupled to the first cleaner 200. The battery 240 may be separably coupled to the battery housing 230. For example, the battery 240 may be inserted into the battery housing 230 from the lower side of the battery housing 230. The above-mentioned configuration may improve portability of the first cleaner 200.

Otherwise, the battery 240 may be integrally provided in the battery housing 230. In this case, a lower surface of the battery 240 is not exposed to the outside.

The battery 240 may supply power to the suction motor 214 of the first cleaner 200. The battery 240 may be disposed on a lower portion of the handle 216. The battery 240 may be disposed at a rear side of the dust bin 220. That is, the suction motor 214 and the battery 240 may be disposed so as not to overlap each other in the upward/downward direction and disposed at different disposition heights. On the basis of the handle 216, the suction motor 214, which is heavy in weight, is disposed at a front side of the handle 216, and the battery 240, which is heavy in weight, is disposed at the lower side of the handle 216, such that an overall weight of the cleaner 200 may be uniformly distributed. Therefore, it is possible to prevent stress from being applied to the user's wrist when the user grasps the handle 216 and performs a cleaning operation.

In a case in which the battery 240 is coupled to the battery housing 230 in accordance with the embodiment, the lower surface of the battery 240 may be exposed to the outside. Because the battery 240 may be placed on the floor when the first cleaner 200 is placed on the floor, the battery 240 may be immediately separated from the battery housing 230. In addition, because the lower side of the battery 240 is exposed to the outside and thus in direct contact with air outside the battery 240, performance of cooling the battery 240 may be improved.

Meanwhile, in a case in which the battery 240 is fixed integrally to the battery housing 230, the number of structures for attaching or detaching the battery 240 and the battery housing 230 may be reduced, and as a result, it is possible to reduce an overall size of the cleaner 200 and a weight of the cleaner 200.

The first cleaner 200 may include the extension tube 250. The extension tube 250 may communicate with a cleaning module 260. The extension tube 250 may communicate with the main body 210. The extension tube 250 may communicate with the suction part 214 of the main body 210. The extension tube 250 may be formed in a long cylindrical shape.

The main body 210 may be connected to the extension tube 250. The main body 210 may be connected to the cleaning module 260 through the extension tube 250. The main body 210 may generate the suction force by means of the suction motor 214 and provide the suction force to the cleaning module 260 through the extension tube 250. The outside dust may be introduced into the main body 210 through the cleaning module 260 and the extension tube 250.

The first cleaner 200 may include the cleaning module 260. The cleaning module 260 may communicate with the extension tube 250. Therefore, the outside air may be introduced into the main body 210 of the first cleaner 200 via the cleaning module 260 and the extension tube 250 by the suction force generated in the main body 210 of the first cleaner 200.

The dust in the dust bin 220 of the first cleaner 200 may be captured by a dust collecting part 170 of the cleaner station 100 by gravity and a suction force of a dust collecting motor 191. Therefore, it is possible to remove the dust in the dust bin without the user's separate manipulation, thereby providing convenience for the user. In addition, it is possible to eliminate the inconvenience caused because the user needs to empty the dust bin all the time. In addition, it is possible to prevent the dust from scattering when emptying the dust bin.

The first cleaner 200 may be coupled to a lateral surface of a housing 110. Specifically, the main body 210 of the first cleaner 200 may be mounted on a coupling part 120. More specifically, the dust bin 220 and the battery housing 230 of the first cleaner 200 may be coupled to a coupling surface 121, an outer circumferential surface of the dust bin main body 221 may be coupled to a dust bin guide surface 122, and the suction part 212 may be coupled to a suction part guide surface 126 of the coupling part 120. In this case, a central axis of the dust bin 220 may be disposed in a direction parallel to the ground surface, and the extension tube 250 may be disposed in a direction perpendicular to the ground surface (see FIG. 2).

The cleaner system 10 may include the second cleaner 300. The second cleaner 300 may mean a robot cleaner. The second cleaner 300 may automatically clean a zone to be cleaned by sucking foreign substances such as dust from the floor while autonomously traveling in the zone to be cleaned. The second cleaner 300, that is, the robot cleaner may include a distance sensor configured to detect a distance from an obstacle such as furniture, office supplies, or walls installed in the zone to be cleaned, and left and right wheels for moving the robot cleaner. The second cleaner 300 may be coupled to the cleaner station 100. The dust in the second cleaner 300 may be captured into the dust collecting part 170 through a second flow path part 182.

The cleaner station 100 of the present disclosure will be described below with reference to FIGS. 1 and 2.

The first cleaner 200 and the second cleaner 300 may be disposed on the cleaner station 100. The first cleaner 200 may be coupled to the lateral surface of the cleaner station 100. Specifically, the main body of the first cleaner 200 may be coupled to the lateral surface of the cleaner station 100. The second cleaner 300 may be coupled to the lower portion of the cleaner station 100. The cleaner station 100 may remove dust from the dust bin 220 of the first cleaner 200. The cleaner station 100 may remove dust from the dust bin (not illustrated) of the second cleaner 300.

The cleaner station 100 may include the housing 110. The housing 110 may define an external appearance of the cleaner station 100. Specifically, the housing 110 may be provided in the form of a column including one or more outer wall surfaces. For example, the housing 110 may be formed in a shape similar to a quadrangular column.

The housing 110 may have a space capable of accommodating the dust collecting part 170 configured to store dust therein, and a dust suction module 190 configured to generate a flow force for collecting the dust in the dust collecting part 170.

The housing 110 may include a bottom surface 111, an outer wall surface 112, and an upper surface 113.

The bottom surface 111 may support a lower side in a gravitational direction of the dust suction module 190. That is, the bottom surface 111 may support a lower side of the dust collecting motor 191 of the dust suction module 190.

In this case, the bottom surface 111 may be disposed toward the ground surface. The bottom surface 111 may also be disposed in parallel with the ground surface or disposed to be inclined at a predetermined angle with respect to the ground surface. The above-mentioned configuration may be advantageous in stably supporting the dust collecting motor 171 and maintaining balance of an overall weight even in a case in which the first cleaner 200 is coupled.

Meanwhile, according to the embodiment, the bottom surface 111 may further include ground surface support portions 111a in order to prevent the cleaner station 100 from falling down and increase an area being in contact with the ground surface to maintain the balance. For example, the ground surface support portion may have a plate shape extending from the bottom surface 111, and one or more frames may protrude and extend from the bottom surface 111 in a direction of the ground surface.

The outer wall surface 112 may mean a surface formed in the gravitational direction or a surface connected to the bottom surface 111. For example, the outer wall surface 112 may mean a surface connected to the bottom surface 111 so as to be perpendicular to the bottom surface 111. As another embodiment, the outer wall surface 112 may be disposed to be inclined at a predetermined angle with respect to the bottom surface 111.

The outer wall surface 112 may include at least one surface. For example, the outer wall surface 112 may include a first outer wall surface 112a, a second outer wall surface 112b, a third outer wall surface 112c, and a fourth outer wall surface 112d.

In this case, in the present embodiment, the first outer wall surface 112a may be disposed at the front side of the cleaner station 100. In this case, the front side may mean a side at which the first cleaner 200 is exposed in the state in which the first cleaner 200 is coupled to the cleaner station 100. Therefore, the first outer wall surface 112a may define an external appearance of the front side of the cleaner station 100.

Meanwhile, the directions are defined as follows to understand the present embodiment. In the present embodiment, the directions may be defined in the state in which the first cleaner 200 is mounted on the cleaner station 100.

In the state in which the first cleaner 200 is mounted on the cleaner station 100, a direction in which the first cleaner 200 is exposed to the outside of the cleaner station 100 may be referred to as a forward direction.

In another point of view, in the state in which the first cleaner 200 is mounted on the cleaner station 100, a direction in which the suction motor 214 of the first cleaner 200 is disposed may be referred to as the forward direction. Further, a direction opposite to the direction in which the suction motor 214 is disposed on the cleaner station 100 may be referred to as a rearward direction.

In still another point of view, a direction in which an intersection point at which the grip portion through line a3 and the suction motor axis a1 intersect is disposed may be referred to as the forward direction on the basis of the cleaner station 100. Alternatively, a direction in which an intersection point P2 at which the grip portion through line a3 and the suction flow path through line a2 intersect is disposed may be referred to as the forward direction. Alternatively, a direction in which an intersection point P1 at which the suction motor axis a1 and the suction flow path through line a2 intersect is disposed may be referred to as the forward direction. Further, a direction opposite to the direction in which the intersection point is disposed may be referred to as the rearward direction on the basis of the cleaner station 100.

Further, on the basis of the internal space of the housing 110, a surface facing the front surface may be referred to as a rear surface of the cleaner station 100. Therefore, the rear surface may mean a direction in which the second outer wall surface 112b is formed.

Further, on the basis of the internal space of the housing 110, a left surface when viewing the front surface may be referred to as a left surface, and a right surface when viewing the front surface may be referred to as a right surface. Therefore, the left surface may mean a direction in which the third outer wall surface 112c is formed, and the right surface may mean a direction in which the fourth outer wall surface 112d is formed.

The first outer wall surface 112a may be formed in the form of a flat surface, or the first outer wall surface 112a may be formed in the form of a curved surface as a whole or formed to partially include a curved surface.

The first outer wall surface 112a may have an external appearance corresponding to the shape of the first cleaner 200. In detail, the coupling part 120 may be disposed on the first outer wall surface 112a. With this configuration, the first cleaner 200 may be coupled to the cleaner station 100 and supported by the cleaner station 100. The specific configuration of the coupling part 120 will be described below.

Meanwhile, a structure for mounting various types of cleaning modules 260 used for the first cleaner 200 may be additionally provided on the first outer wall surface 112a.

In addition, a structure to which the second cleaner 300 may be coupled may be additionally provided on the first outer wall surface 112a. Therefore, the structure corresponding to the shape of the second cleaner 300 may be additionally provided on the first outer wall surface 112a.

Further, a cleaner bottom plate (not illustrated) to which the lower surface of the second cleaner 300 may be coupled may be additionally coupled to the first outer wall surface 112a. Meanwhile, as another embodiment, the cleaner bottom plate (not illustrated) may be shaped to be connected to the bottom surface 111.

In the present embodiment, the second outer wall surface 112b may be a surface facing the first outer wall surface 112a. That is, the second outer wall surface 112b may be disposed on the rear surface of the cleaner station 100. In this case, the rear surface may be a surface facing the surface to which the first cleaner 200 or the second cleaner 300 is coupled.

Therefore, the second outer wall surface 112b may define an external appearance of the rear surface of the cleaner station 100.

For example, the second outer wall surface 112b may be formed in the form of a flat surface. With this configuration, the cleaner station 100 may be in close contact with a wall in a room, and the cleaner station 100 may be stably supported.

As another example, the structure for mounting various types of cleaning modules 290 used for the first cleaner 200 may be additionally provided on the second outer wall surface 112b.

In the present embodiment, the third outer wall surface 112c and the fourth outer wall surface 112d may mean surfaces that connect the first outer wall surface 112a and the second outer wall surface 112b. In this case, the third outer wall surface 112c may be disposed on the left surface of the station 100, and the fourth outer wall surface 112d may be disposed on the right surface of the cleaner station 100. Otherwise, the third outer wall surface 112c may be disposed on the right surface of the cleaner station 100, and the fourth outer wall surface 112d may be disposed on the left surface of the cleaner station 100.

The third outer wall surface 112c or the fourth outer wall surface 112d may be formed in the form of a flat surface, or the third outer wall surface 112c or the fourth outer wall surface 112d may be formed in the form of a curved surface as a whole or formed to partially include a curved surface.

Meanwhile, the structure for mounting various types of cleaning modules 290 used for the first cleaner 200 may be additionally provided on the third outer wall surface 112c or the fourth outer wall surface 112d.

The upper surface 113 may define an upper external appearance of the cleaner station. That is, the upper surface 113 may mean a surface disposed at an outermost side of the cleaner station in the gravitational direction and exposed to the outside.

For reference, in the present embodiment, the terms ‘upper side’ and ‘lower side’ may mean the upper and lower sides in the gravitational direction (a direction perpendicular to the ground surface) in the state in which the cleaner station 100 is installed on the ground surface.

In this case, the upper surface 113 may also be disposed in parallel with the ground surface or disposed to be inclined at a predetermined angle with respect to the ground surface.

A display part 410 may be disposed on the upper surface 113. For example, the display part 410 may display a state of the cleaner station 100, a state of the first cleaner 200, and a state of the second cleaner 300. The display part 410 may further display information such as a cleaning process situation, a map of the cleaning zone, and the like.

Meanwhile, according to the embodiment, the upper surface 113 may be separable from the outer wall surface 112. In this case, when the upper surface 113 is separated, the battery separated from the cleaner 200 or 300 may be accommodated in the internal space surrounded by the outer wall surface 112, and a terminal (not illustrated) capable of charging the separated battery.

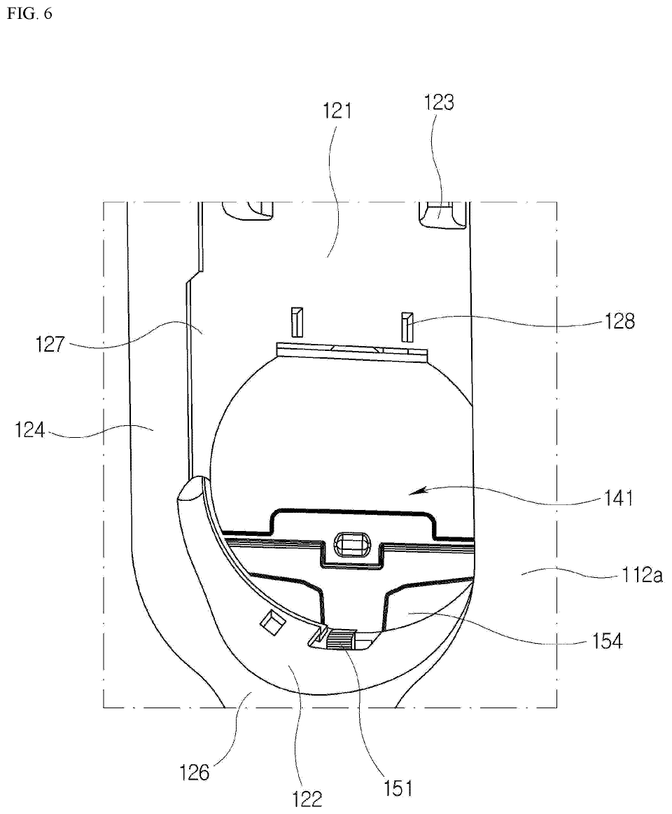

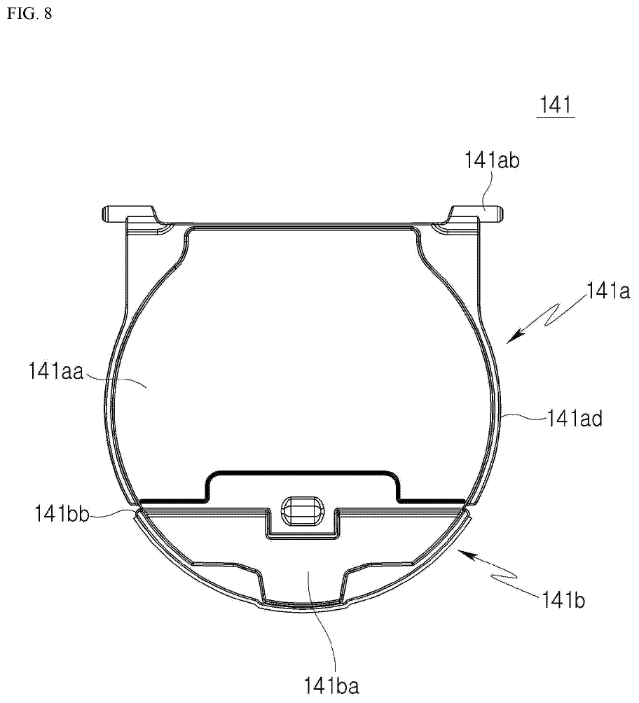

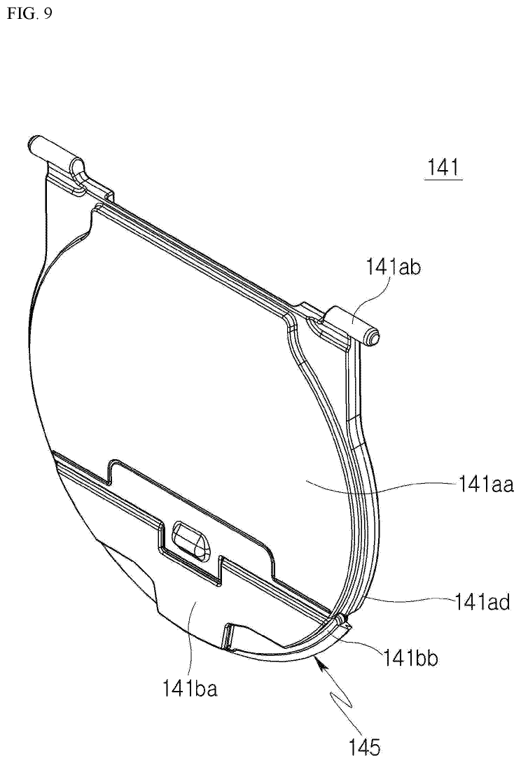

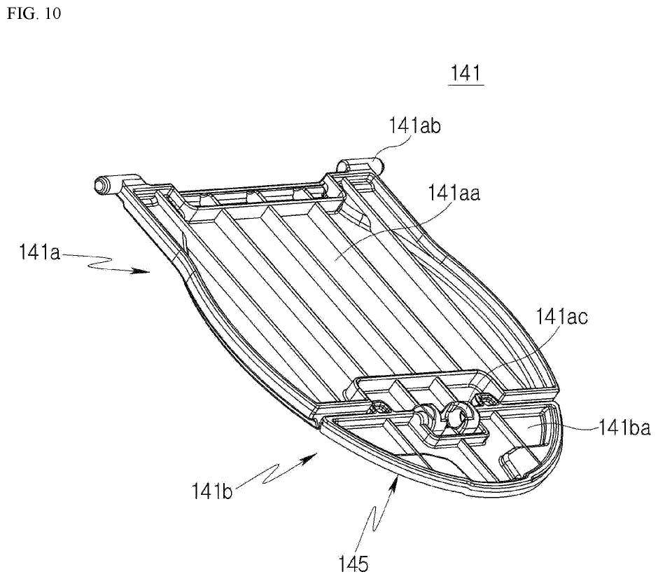

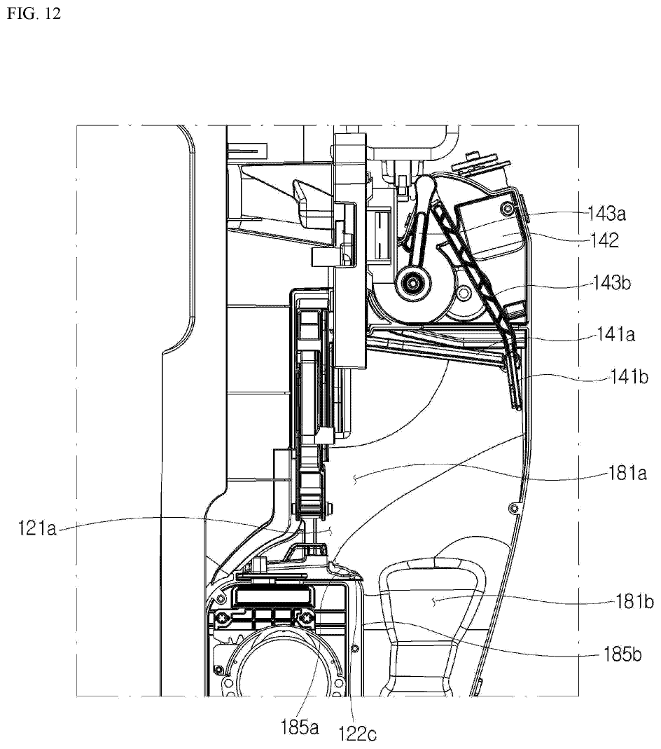

FIG. 6 is a view for explaining the coupling part of the cleaner station according to the embodiment of the present disclosure, FIG. 7 is a perspective view for explaining a fixing unit of the cleaner station according to the embodiment of the present disclosure, FIGS. 8 to 11 are views for explaining a relationship between the first cleaner and a door unit in the cleaner station according to the embodiment of the present disclosure, and FIG. 12 is a view for explaining a relationship between the first cleaner and a cover opening unit in the cleaner station according to the embodiment of the present disclosure.

The coupling part 120 of the cleaner station 100 according to the present disclosure will be described below with reference to FIGS. 2 and 6.

The cleaner station 100 may include the coupling part 120 to which the first cleaner 200 is coupled. Specifically, the coupling part 120 may be disposed in the first outer wall surface 112a, and the main body 210, the dust bin 220, and the battery housing 230 of the first cleaner 200 may be coupled to the coupling part 120.

The coupling part 120 may include the coupling surface 121. The coupling surface 121 may be disposed on the lateral surface of the housing 110. For example, the coupling surface 121 may mean a surface formed in the form of a groove which is concave toward the inside of the cleaner station 100 from the first outer wall surface 112a. That is, the coupling surface 121 may mean a surface formed to have a stepped portion with respect to the first outer wall surface 112a.

The first cleaner 200 may be coupled to the coupling surface 121. For example, the coupling surface 121 may be in contact with the lower surface of the dust bin 220 and the lower surface of the battery housing 230 of the first cleaner 200. In this case, the lower surface may mean a surface directed toward the ground surface when the user uses the first cleaner 200 or places the first cleaner 200 on the ground surface.

For example, an angle of the coupling surface 121 with respect to the ground surface may be a right angle. Therefore, it is possible to minimize a space of the cleaner station 100 when the first cleaner 200 is coupled to the coupling surface 121.

As another example, the coupling surface 121 may be disposed to be inclined at a predetermined angle with respect to the ground surface. Therefore, the cleaner station 100 may be stably supported when the first cleaner 200 is coupled to the coupling surface 121.

The coupling surface 121 may have a dust passage hole 121a through which air outside the housing 110 may be introduced into the housing 110. The dust passage hole 121a may be formed in the form of a hole corresponding to the shape of the dust bin 220 so that the dust in the dust bin 220 may be introduced into the dust collecting part 170. The dust passage hole 121a may be formed to correspond to the shape of the discharge cover 222 of the dust bin 220. The dust passage hole 121a may be formed to communicate with a first cleaner flow path part 181 to be described below.

The coupling part 120 may include the dust bin guide surface 122. The dust bin guide surface 122 may be disposed on the first outer wall surface 112a. The dust bin guide surface 122 may be connected to the first outer wall surface 112a. In addition, the dust bin guide surface 122 may be connected to the coupling surface 121.

The dust bin guide surface 122 may be formed in a shape corresponding to the outer surface of the dust bin 220. A front outer surface of the dust bin 220 may be coupled to the dust bin guide surface 122. Therefore, it is possible to provide convenience when coupling the first cleaner 200 to the coupling surface 121.

Meanwhile, a protrusion moving hole 122a may be formed in the dust bin guide surface 122, and a push protrusion 151 to be described below may rectilinearly move along the protrusion moving hole 122a. In addition, a gearbox 155 may be provided below the dust bin guide surface 122 based on the gravitational direction and accommodate a gear or the like of a cover opening unit 150 to be described below. In this case, a guide space 122b, through which the push protrusion 151 may move, may be formed between the dust bin guide surface 122, the lower surface, and the upper surface of the gearbox 155. Further, the guide space 122b may communicate with a first flow path 181a of the first cleaner flow path part 181 through a bypass hole 122c. That is, the protrusion moving hole 122a, the guide space 122b, the bypass hole 122c, and the first flow path 181a may define one bypass flow path (see FIG. 8). With this configuration, when the dust collecting motor 191 operates in the state in which the dust bin 220 is coupled to the coupling part 120, the dust or the like, which remains in the dust bin 220 and remains on the dust bin guide surface 122, may be sucked through the bypass flow path.

The coupling part 120 may include guide protrusions 123. The guide protrusions 123 may be disposed on the coupling surface 121. The guide protrusions 123 may protrude upward from the coupling surface 121. Two guide protrusions 123 may be disposed to be spaced apart from each other. A distance between the two guide protrusions 123, which are spaced apart from each other, may correspond to a width of the battery housing 230 of the first cleaner 200. Therefore, it is possible to provide convenience when coupling the first cleaner 200 to the coupling surface 121.

The coupling part 120 may include coupling part sidewalls 124. The sidewalls 124 may mean wall surfaces disposed at two opposite sides of the coupling surface 121 and may be perpendicularly connected to the coupling surface 121. The coupling part sidewalls 124 may be connected to the first outer wall surface 112a. In addition, the coupling part sidewalls 124 may define surfaces connected to the dust bin guide surface 122. Therefore, the first cleaner 200 may be stably accommodated.

The coupling part 120 may include a coupling sensor 125. The coupling sensor 125 may detect whether the first cleaner 200 is coupled to the coupling part 120.

The coupling sensor 125 may include a contact sensor. For example, the coupling sensor 125 may include a micro-switch. In this case, the coupling sensor 125 may be disposed on the guide protrusion 123. Therefore, when the battery housing 230 or the battery 240 of the first cleaner 200 is coupled between the pair of guide protrusions 123, the battery housing 230 or the battery 240 comes into contact with the coupling sensor 125, such that the coupling sensor 125 may detect that the first cleaner 200 is coupled to the cleaner station 100.

Meanwhile, the coupling sensor 125 may include a contactless sensor. For example, the coupling sensor 125 may include an infrared ray (IR) sensor. In this case, the coupling sensor 125 may be disposed on the coupling part sidewall 124. Therefore, when the dust bin 220 or the main body 210 of the first cleaner 200 passes the coupling part sidewall 124 and then reaches the coupling surface 121, the coupling sensor 125 may detect the presence of the dust bin 220 or the main body 210.

The coupling sensor 125 may face the dust bin 220 or the battery housing 230 of the first cleaner 200.

The coupling sensor 125 may be a mean for determining whether the first cleaner 200 is coupled and power is applied to the battery 240 of the first cleaner 200.

The coupling part 120 may include the suction part guide surface 126. The suction part guide surface 126 may be disposed on the first outer wall surface 112a. The suction part guide surface 126 may be connected to the dust bin guide surface 122. The suction part 212 may be coupled to the suction part guide surface 126. The suction part guide surface 126 may be formed in a shape corresponding to the shape of the suction part 212.

The coupling part 120 may further include fixing member entrance holes 127. The fixing member entrance hole 127 may be formed in the form of a long hole along the coupling part sidewall 124 so that fixing members 131 may enter and exit the fixing member entrance hole 127.

With this configuration, when the user couples the first cleaner 200 to the coupling part 120 of the cleaner station 100, the main body 210 of the first cleaner 200 may be stably disposed on the coupling part 120 by the dust bin guide surface 122, the guide protrusions 123, and the suction part guide surface 126. Therefore, it is possible to provide convenience when coupling the dust bin 220 and the battery housing 230 of the first cleaner 200 to the coupling surface 121.

Meanwhile, the cleaner station 100 may further include a charging part 128. The charging part 128 may be disposed on the coupling part 120. The charging part 128 may be electrically connected to the first cleaner 200 coupled to the coupling part 120. The charging part 128 may supply power to the battery of the first cleaner 200 coupled to the coupling part 120. In this case, the charging part 128 may be a means capable of detecting that the first cleaner 200 is coupled to the cleaner station 100 through the electrical connection with the first cleaner 200. In addition, the charging part 128 may be a means for transmitting a predetermined electrical signal to the first cleaner 200 and allowing a control unit of the first cleaner 200 to detect the coupling between the first cleaner 200 and the cleaner station 100.

In addition, the charging part 128 may include a lower charging part (not illustrated) disposed in a lower region of the housing 110. The lower charging part may be electrically connected to the second cleaner 300 coupled to the lower region of the housing 110. A second charger may supply power to the battery of the second cleaner 300 coupled to the lower region of the housing 110.

A fixing unit 130 according to the present disclosure will be described below with reference to FIGS. 2 and 7.

The cleaner station 100 according to the present disclosure may include the fixing unit 130. The fixing unit 130 may be disposed on the coupling part sidewall 124. In addition, the fixing unit 130 may be disposed on a back surface to the coupling surface 121. The fixing unit 130 may fix the first cleaner 200 coupled to the coupling surface 121. Specifically, the fixing unit 130 may fix the dust bin 220 and the battery housing 230 of the first cleaner 200 coupled to the coupling surface 121.

The fixing unit 130 may include the fixing members 131 configured to fix the dust bin 220 and the battery housing 230 of the first cleaner 200, and a fixing part motor 133 configured to operate the fixing members 131. In addition, the fixing unit 130 may further include fixing part links 135 configured to transmit power of the fixing part motor 133 to the fixing members 131.

The fixing member 131 may be disposed on the coupling part sidewall 124 and provided on the coupling part sidewall 124 so as to reciprocate in order to fix the dust bin 220. Specifically, the fixing members 131 may be accommodated in the fixing member entrance holes 127.

The fixing members 131 may be disposed at two opposite sides of the coupling part 120, respectively. For example, a pair of two fixing members 131 may be symmetrically disposed with respect to the coupling surface 121.

The fixing part motor 133 may provide power for moving the fixing member 131.

The fixing part links 135 may convert a rotational force of the fixing part motor 133 into the reciprocations of the fixing members 131.

A stationary sealer 136 may be disposed on the dust bin guide surface 122 so as to seal the dust bin 220 when the first cleaner 200 is coupled. With this configuration, when the dust bin 220 of the cleaner 200 is coupled, the cleaner 200 may press the stationary sealer 136 by its own weight, such that the dust bin 220 and the dust bin guide surface 122 may be sealed.

The stationary sealer 136 may be disposed on an imaginary extension line of the fixing member 131. With this configuration, when the fixing part motor 133 operates and the fixing members 131 press the dust bin 220, a circumference of the dust bin 220 at the same height may be sealed.

According to the embodiment, the stationary sealer 136 may be disposed on the dust bin guide surface 122 and formed in the form of a bent line corresponding to an arrangement of a cover opening unit 150 to be described below.

Therefore, when the main body 210 of the first cleaner 200 is disposed on the coupling part 120, the fixing unit 130 may fix the main body 210 of the first cleaner 200. Specifically, when the coupling sensor 125 detects that the main body 210 of the first cleaner 200 is coupled to the coupling part 120 of the cleaner station 100, the fixing part motor 133 may move the fixing members 131 to fix the main body 210 of the first cleaner 200.

Therefore, it is possible to improve the suction force of the cleaner by preventing the residual dust from remaining in the dust bin. Further, it is possible to remove an offensive odor caused by the residual dust by preventing the residual dust from remaining in the dust bin.

A door unit 140 according to the present disclosure will be described below with reference to FIGS. 2 and 8 to 12.

The cleaner station 100 according to the present disclosure may include the door unit 140. The door unit 140 may be configured to open or close the dust passage hole 121a.

The door unit 140 may include a door 141, a door motor 142, and a door arm 143.

The door 141 may be hingedly coupled to the coupling surface 121 and may open or close at least a part of the dust passage hole 121a.

In the present embodiment, the door 141 may include a first door 141a and a second door 141b. In this case, the first door 141a and the second door 141b are coupled to define a circular shape as a whole. Further, the door 141, which is configured by coupling the first door 141a and the second door 141b, may open or close the dust passage hole 121a.

The first door 141a may include a first door main body 141aa, a hinge part 141ab, and an arm coupling part 141ac.

The first door main body 141aa may be formed in a shape capable of blocking at least a part of the dust passage hole 121a. For example, the first door main body 141aa may be formed in a shape similar to a shape made by cutting a part of a circular plate. On the basis of a state in which the first door main body 141aa blocks the dust passage hole 121a, the hinge part 141ab may be disposed at an upper side of the first door main body 141aa, and the arm coupling part 141ac may be disposed at a lower side of the first door main body 141aa.

The hinge part 141ab may be a means by which the first door 141a is hingedly coupled to the coupling surface 121. The hinge part 141ab may be disposed at an upper end of the first door main body 141aa and coupled to the coupling surface 121.

The arm coupling part 141ac may be a means to which the door arm 143 is rotatably coupled. The arm coupling part 141ac may be disposed at a lower side of the inner surface of the first door 141a, and the door arm 143 may be rotatably coupled to the arm coupling part 141ac. For example, the arm coupling part 141ac may extend downward from a lower end of the first door main body 141aa, and an end of a second door arm 143b may be rotatably coupled to the arm coupling part 141ac.

The second door 141b may be hingedly coupled to the first door 141a and block at least a part of the dust passage hole 121a.

The first door 141a and the second door 141b may be rotatably coupled at a position of a reference line that separates the first door 141a and the second door 141b. For example, the first door 141a and the second door 141b may be hingedly coupled at the position of the reference line. In this case, an axis on which the first door 141a and the second door 141b are hingedly coupled may be disposed coaxially with an axis on which the door arm 143 and the first door 141a are rotatably coupled. In addition, in this case, on the basis of a state in which the dust passage hole 121a is closed, the first door 141a may be disposed at the upper side of the dust passage hole 121a, and the second door 141b may be disposed at the lower side of the dust passage hole 121a. In addition, the reference line may be formed such that the first door 141a has a larger area than the second door 141b.

The second door 141b may include a second door main body 141ba. The second door main body 141ba may be hingedly coupled to the first door 141a and formed in a shape capable of blocking at least a part of the dust passage hole 121a. For example, the second door main body 141ba may be formed in a shape similar to a shape made by cutting a part of a circular plate. A groove may be formed at an upper end of the second door main body 141ba to accommodate the arm coupling part 141ac of the first door 141a.

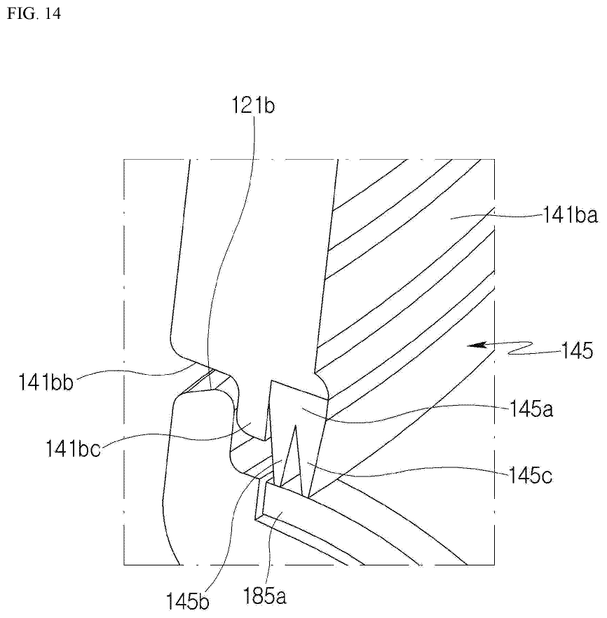

With reference to FIG. 14, the door 141 may be formed in a shape capable of sealing the dust passage hole 121a. For example, the first door 141a and the second door 141b may be coupled to define a circular plate shape having a predetermined thickness as a whole. In this case, an outer peripheral surface of the door 141, which has a circular plate shape as a whole, may include a first door outer wall surface 141ad and a second door outer wall surface 141bb. That is, the first door outer wall surface 141ad may be a surface formed at an outer end of the first door 141a and have an arc shape as a whole entirely. In addition, the second door outer wall surface 141bb may be a surface formed at an outer end of the second door 141b and have an arc shape as a whole.

In this case, the first door outer wall surface 141ad and the second door outer wall surface 141bb may be disposed to face a sidewall 121b of the dust passage hole 121a in the state in which the door 141 blocks the dust passage hole 121a.

Meanwhile, stoppers 141ae and 141bc may protrude radially outward from the first door outer wall surface 141ad and/or the second door outer wall surface 141bb. In this case, a maximum diameter of the door 141 including the stoppers 141ae and 141bc may be larger than a maximum diameter of the dust passage hole 121a.

Therefore, the stoppers 141ae and 141bc rotate in the housing 110 together with the door 141 as the door 141 rotates. In case that the door 141 blocks the dust passage hole 121a, the stoppers 141ae and 141bc may be supported by coming into contact with the sidewall 121b of the dust passage hole 121a, and the door 141 may seal the dust passage hole 121a.

With this configuration, when the door arm 143 pulls the first door main body 141aa in the state in which the door 141 closes the dust passage hole 121a, the first door main body 141aa is rotated about the hinge part 141ab toward the inside of the cleaner station 100, such that the dust passage hole 121a may be opened. In this case, when the first door main body 141aa rotates, the second door main body 141ba may rotate in a direction opposite to the rotation direction of the first door main body 141aa while being moved downward by gravity. That is, the first door 141a and the second door 141b may be folded when the door 141 is opened. With this configuration, it is possible to prevent damage to the door 141 during the process of opening the door 141.

Meanwhile, when the door arm 143 pushes the first door main body 141aa in the state in which the dust passage hole 121a is opened, the first door main body 141aa is rotated about the hinge part 141ab toward the outside of the cleaner station 100, such that the dust passage hole 121a may be blocked.

The door motor 142 may provide power for rotating the door 141. Specifically, the door motor 142 may rotate the door arm 143 in a forward or reverse direction. In this case, the forward direction may mean a direction in which the door arm 143 pulls the door 141. Therefore, when the door arm 143 is rotated in the forward direction, the dust passage hole 121a may be opened. In addition, the reverse direction may mean a direction in which the door arm 143 pushes the door 141. Therefore, when the door arm 143 is rotated in the reverse direction, at least a part of the dust passage hole 121a may be closed. The forward direction may be opposite to the reverse direction.

The door arm 143 may connect the door 141 and the door motor 142 and open or close the door 141 using the power generated from the door motor 142.

For example, the door arm 143 may include a first door arm 143a and the second door arm 143b. One end of the first door arm 143a may be coupled to the door motor 142. The first door arm 143a may be rotated by the power of the door motor 142. The other end of the first door arm 143a may be rotatably coupled to the second door arm 143b. The first door arm 143a may transmit a force transmitted from the door motor 142 to the second door arm 143b. One end of the second door arm 143b may be coupled to the first door arm 143a. The other end of the second door arm 143b may be coupled to the first door 141a. The second door arm 143b may open or close the dust passage hole 121a by pushing or pulling the first door 141a.

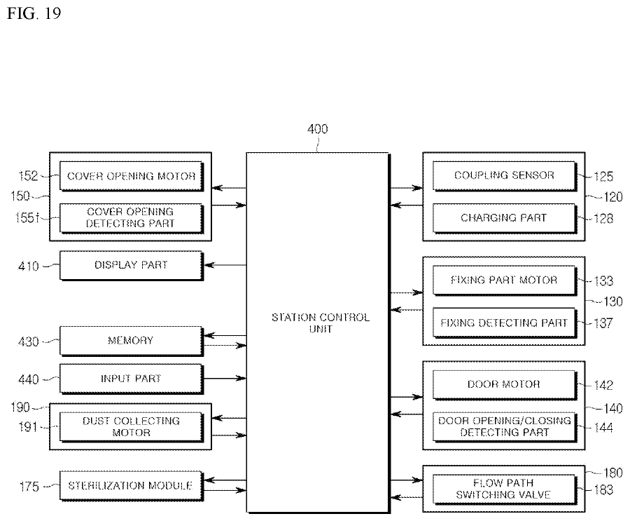

The door unit 140 may further include door opening/closing detecting parts 144 (see FIG. 19). The door opening/closing detecting parts 144 may be provided in the housing 100 and may detect whether the door 141 is in an opened state.

For example, the door opening/closing detecting parts 144 may be disposed at both ends in a rotational region of the door arm 143, respectively. As another example, the door opening/closing detecting parts 144 may be disposed at both ends in a movement region of the door 141, respectively.

Therefore, when the door arm 143 is moved to a preset door opening position DP1 or when the door 141 is opened to a predetermined position, the door opening/closing detecting parts 144 may detect that the door is opened. In addition, when the door arm 143 is moved to a preset door closing position DP2 or when the door 141 is opened to a predetermined position, the door opening/closing detecting parts 144 may detect that the door is opened.

The door opening/closing detecting part 144 may include a contact sensor. For example, the door opening/closing detecting part 144 may include a micro-switch.

Meanwhile, the door opening/closing detecting part 144 may also include a contactless sensor. For example, the door opening/closing detecting part 144 may include an infrared ray (IR) sensor.

With this configuration, the door unit 140 may selectively open or close at least a part of the coupling surface 121, thereby allowing the outside of the first outer wall surface 112a to communicate with the first cleaner flow path part 181 and/or the dust collecting part 170.

The door unit 140 may be opened when the discharge cover 222 of the first cleaner 200 is opened. In addition, when the door unit 140 is closed, the discharge cover 222 of the first cleaner 200 may also be closed.

When the dust in the dust bin 220 of the first cleaner 200 is removed, the door motor 142 may rotate the door 141, thereby coupling the discharge cover 222 to the dust bin main body 221. Specifically, the door motor 142 may rotate the door 141 to rotate the door 141 about the hinge part 141ab, and the door 141 rotated about the hinge part 141ab may push the discharge cover 222 toward the dust bin main body 221.

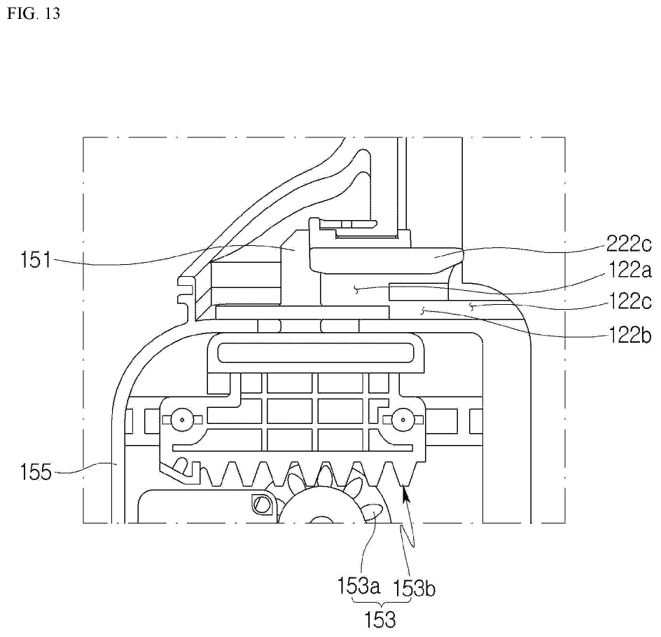

Meanwhile, the door unit 140 according to the embodiment of the present disclosure may further include a scraper 145. The scraper 145 may be coupled to the door 141. When the door blocks the dust passage hole 121a, the scraper 145 may come into contact with at least a part of a flow path tube 185 that defines a flow path part 180. A configuration and effect of the scraper 145 will be described below in detail with reference to FIGS. 13 to 17.

The cover opening unit 150 according to the present disclosure will be described below with reference to FIGS. 2, 5, and 13.

The cleaner station 100 according to the present disclosure may include the cover opening unit 150. The cover opening unit 150 may be disposed on the coupling part 120 and may open the discharge cover 222 of the first cleaner 200.

The cover opening unit 150 may include the push protrusion 151, a cover opening motor 152, cover opening gears 153, a support plate 154, and the gear box 155.

The push protrusion 151 may move to press the coupling lever 222c when the first cleaner 200 is coupled.

The push protrusion 151 may be disposed on the dust bin guide surface 122. Specifically, the protrusion moving hole may be formed in the dust bin guide surface 122, and the push protrusion 151 may be exposed to the outside by passing through the protrusion moving hole.

When the first cleaner 100 is coupled, the push protrusion 151 may be disposed at a position at which the push protrusion 151 may push the coupling lever 222c. That is, the coupling lever 222c may be disposed on the protrusion moving hole. In addition, the coupling lever 222c may be disposed in a movement region of the push protrusion 151.

The push protrusion 151 may rectilinearly reciprocate to press the coupling lever 222c. Specifically, the push protrusion 151 may be coupled to the gear box 155, such that the rectilinear movement of the push protrusion 151 may be guided. The push protrusion 151 may be coupled to the cover opening gears 153 and moved together with the cover opening gears 153 by the movements of the cover opening gears 153.

The cover opening motor 152 may provide power for moving the push protrusion 151. Specifically, the cover opening motor 152 may rotate a motor shaft (not illustrated) in a forward direction or a reverse direction. In this case, the forward direction may mean a direction in which the push protrusion 151 pushes the coupling lever 222c. In addition, the reverse direction may mean a direction in which the push protrusion 151, which has pushed the coupling lever 222c, returns back to an original position. The forward direction may be opposite to the reverse direction.

The cover opening gears 153 may be coupled to the cover opening motor 152 and may move the push protrusion 151 using the power from the cover opening motor 152. Specifically, the cover opening gears 153 may be accommodated in the gear box 155. A driving gear 153a of the cover opening gears 153 may be coupled to the motor shaft of the cover opening motor 152 and supplied with the power. A driven gear 153b of the cover opening gears 153 may be coupled to the push protrusion 151 to move the push protrusion 151. For example, the driven gear 153b may be provided in the form of a rack gear, engage with the driving gear 153a, and receive power from the driving gear 153a.

In this case, the discharge cover 222 may have the torsion spring 222d. The discharge cover 222 may be rotated by a predetermined angle or more and supported in the rotated position by an elastic force of the torsion spring 222d. Therefore, the discharge cover 222 may be opened, and the dust passage hole 121a and the inside of the dust bin 220 may communicate with each other.

The support plate 154 may be provided to support one surface of the dust bin 220. Specifically, the support plate 154 may extend from the coupling surface 121. The support plate 154 may protrude and extend toward a center of the dust passage hole 121a from the coupling surface 121 (see FIG. 6).

The gear box 155 may be disposed in the housing 110 and disposed at the lower side of the coupling part 120 in the gravitational direction, and the cover opening gears 153 may be accommodated in the gear box 155.

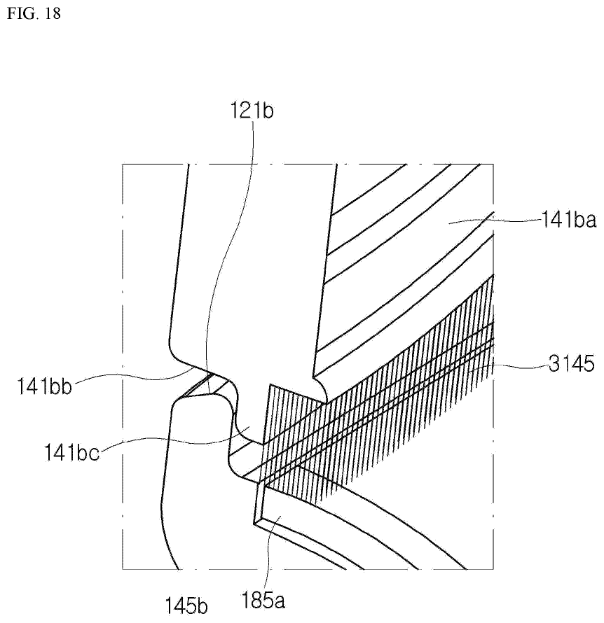

Cover opening detecting parts 155f may be disposed on the gear box 155 (see FIG. 18). In this case, the cover opening detecting part 155f may include a contact sensor. For example, the cover opening detecting part 155f may include a micro-switch. Meanwhile, the cover opening detecting part 155f may also include a contactless sensor. For example, the cover opening detecting part 155f may include an infrared (IR) sensor.

The cover opening detecting part 155f may be disposed on at least one of inner and outer walls of the gear box 155. For example, the single cover opening detecting part 155f may be disposed on the inner surface of the gear box 155. In this case, the cover opening detecting part 155f may detect that the push protrusion 151 is positioned at the initial position.

As another example, the two cover opening detecting parts 155f may be disposed on the outer surface of the gear box 155. In this case, the cover opening detecting part 155f may detect the initial position and the cover opening position of the push protrusion 151.

Accordingly, according to the present disclosure, the cover opening unit 150 may open the dust bin 220 even though the user separately opens the discharge cover 222 of the first cleaner, and as a result, it is possible to improve convenience.

In addition, since the discharge cover 222 is opened in the state in which the first cleaner 200 is coupled to the cleaner station 100, it is possible to prevent the dust from scattering.

Meanwhile, the dust collecting part 170 will be described below with reference to FIGS. 2 and 19.

The cleaner station 100 may include the dust collecting part 170. The dust collecting part 170 may be disposed in the housing 110. The dust collecting part 170 may be disposed at a lower side in the gravitational direction of the coupling part 120.

For example, the dust collecting part 170 may mean a dust bag for collecting dust sucked from the inside of the dust bin 220 of the first cleaner 200 by the dust collecting motor 191.

The dust collecting part 170 may be detachably coupled to the housing 110.

Therefore, the dust collecting part 170 may be separated from the housing 110 and discarded, a new dust collecting part 170 may be coupled to the housing 110. That is, the dust collecting part 170 may be defined as a consumable component.

When the suction force is generated by the dust collecting motor 200, a volume of the dust bag is increased, such that the dust may be accommodated in the dust bag. To this end, the dust bag may be made of a material that transmits air but does not transmit foreign substances such as dust. For example, the dust bag may be made of a non-woven fabric material and have a hexahedral shape when the dust bag has an increased volume.

Therefore, it is not necessary for the user to separately bind a bag in which the dust is captured, and as a result, it is possible to improve convenience for the user.

Meanwhile, the cleaner station 100 according to the embodiment of the present disclosure may further include a sterilization module 175.

At least one sterilization module 175 may be provided on the flow path part 180 or provided at the periphery of the dust collecting part 170.

The sterilization module 175 is configured to sterilize the dust captured in the dust collecting part 170. The sterilization module 175 may include a light source configured to emit sterilization light, and a protection panel disposed below the light source and configured to protect the light source.

In this case, the light source may include one or more light-emitting diodes (LEDs) capable of emitting the sterilization light having sterilizing power for removing bacteria. The sterilization light emitted from the light source may have a wavelength that varies depending on types of light-emitting diodes.

For example, the light source may be a light-emitting diode that emits ultraviolet rays within UV-C wavelength ranges. The ultraviolet rays are divided into UV-A rays (315 nm to 400 nm), UV-B rays (280 nm to 315 nm), and UV-C rays (200 nm to 280 nm) based on the wavelengths. The ultraviolet ray in the UV-C region may inhibit the proliferation of microorganisms by damaging DNA double helices of the microorganisms.

Alternatively, as another example, the light source may be a light-emitting diode that emits visible light with a wavelength of 405 nm. The blue light having a wavelength of 405 nm has a wavelength in a boundary region between the visible ray and the ultraviolet ray and has proved sterilizing power.

In order to prevent damage to the light source, the protection panel may be disposed below the light source and spaced apart from the light source at a predetermined distance. In this case, the protection panel may be made of a material that maximize the transmittance of the light source. For example, the protection panel may be made of quartz. It is known that the quartz does not hinder the transmission of the ultraviolet rays in the UV-C region.

The cleaner station 100 according to the embodiment of the present disclosure has the sterilization module 175 that sterilizes the dust collecting part 170 to prevent bacteria from proliferating in the dust collecting part 170, thereby hygienically managing the dust collecting part 170 that stores the sucked dust for a long period of time.

Meanwhile, the cleaner station 100 may further include a lateral door (not illustrated). The lateral door may be disposed in the housing 110. The lateral door may selectively expose the dust collecting part 170 to the outside. Therefore, the user may easily remove the dust collecting part 170 from the cleaner station 100.

Meanwhile, the flow path part 180 will be described below with reference to FIGS. 2, 12, and 19.

The cleaner station 100 may include the flow path part 180. The flow path part 180 may connect the first cleaner 200 or the second cleaner 300 to the dust collecting part 170.

The flow path part 180 may include the first cleaner flow path part 181, the second cleaner flow path part 182, and a flow path switching valve 183.

The first cleaner flow path part 181 may connect the dust bin 220 of the first cleaner 200 to the dust collecting part 170. The first cleaner flow path part 181 may be disposed at a rear side of the coupling surface 121. The first cleaner flow path part 181 may mean a space between the dust bin 220 of the first cleaner 200 and the dust collecting part 170. The first cleaner flow path part 181 may be a space formed at a rear side of the dust passage hole 121a. The first cleaner flow path part 181 may be a flow path bent downward from the dust passage hole 121a, and the dust and the air may flow through the first cleaner flow path part 181.

Specifically, the first cleaner flow path part 181 may include the first flow path 181a and a second flow path 181b. When the first cleaner 200 is coupled to the cleaner station 200 and the dust passage hole 121a is opened, the first flow path 181a communicates with the internal space of the dust bin 220, and the second flow path 181b allows the first flow path 181a to communicate with the internal space of the dust collecting part 170.

For example, the first flow path 181a may be disposed substantially in parallel with the suction motor axis a1 or the dust bin through line a5. In this case, the suction motor axis a1 or the dust bin through line a5 may penetrate the first flow path 181a. That is, a longitudinal axis of the dust bin 220 may penetrate the first flow path 181a in the state in which the first cleaner 200 is coupled to the cleaner station 100.

In addition, the second flow path 181b may be disposed in a direction parallel to a dust collecting motor axis C. That is, a longitudinal axis of the cleaner station 100 may penetrate the second flow path 181b. With this configuration, it is possible to minimize a decrease in suction force of the dust collecting motor 181 in the first flow path 181a and the second flow path 181b.

In this case, the first flow path 181a may be provided at a predetermined angle with respect to the second flow path 181b. For example, an angle between the first flow path 181a and the second flow path 181b may be a right angle. Therefore, the longitudinal axis of the dust bin 220 and the longitudinal axis of the cleaner station 100 may intersect each other in the state in which the first cleaner 200 is coupled to the cleaner station 100. With this configuration, it is possible to minimize an overall volume of the cleaner station 100.

Meanwhile, a length of the first flow path 181a may be equal to or shorter than a length of the second flow path 181b. With this configuration, the suction force of the dust collecting motor 191 may be transmitted to the space in the dust bin 220 even though the entire flow path for removing the dust is bent once.

The dust in the dust bin 220 of the first cleaner 200 may move to the dust collecting part 170 through the first cleaner flow path part 181.

The second cleaner flow path part 182 may connect the second cleaner 300 to the dust collecting part 170. The dust in the second cleaner 300 may move to the dust collecting part 170 through the second cleaner flow path part 182.

The flow path switching valve 183 may be disposed between the dust collecting part 170, the first cleaner flow path part 181, and the second cleaner flow path part 182. The flow path switching valve 183 may selectively open or close the first cleaner flow path part 181 and the second cleaner flow path part 182 connected to the dust collecting part 170. Therefore, it is possible to prevent a decrease in suction force caused when the plurality of flow paths 181 and 182 is opened.

For example, in a case in which only the first cleaner 200 is coupled to the cleaner station 100, the flow path switching valve 183 may connect the first cleaner flow path part 181 to the dust collecting part 170 and disconnect the second cleaner flow path part 182 from the dust collecting part 170.

Meanwhile, in the present embodiment, the flow path part 180 may be provided in the flow path tube 185. In this case, the flow path tube 185 may mean a tube provided in the housing 110. The flow path tube 185 may include a first flow path tube 185a and a second flow path tube 185b. In this case, the first flow path tube 185a may have the first flow path 181a therein, and the second flow path tube 185b may have the second flow path 181b therein. Meanwhile, the first flow path tube 185a and the second flow path tube 185b may be separated based on the bypass hole 122c. That is, based on the bypass hole 122c, the flow path tube 185 disposed above the bypass hole 122c in the gravitational direction may be referred to as the first flow path tube 185a, and the flow path tube 185 disposed below the bypass hole 122c in the gravitational direction may be referred to as the second flow path tube 185b.

Meanwhile, in case that the dust collecting motor 191 operates and dust and foreign substances in the dust bin 220 are sucked into the cleaner station 100, foreign substances containing hairs and the like may be tangled or attached by static electricity or the like to the periphery of the coupling surface 121, the sidewall 121b of the dust passage hole 121a, or an inner peripheral surface of the first flow path tube 185a.

The foreign substances remaining at the periphery of the coupling surface 121 or remaining on the sidewall 121b of the dust passage hole 121a or the inner peripheral surface of the first flow path tube 185a are difficult to remove, and the user may experience the inconvenience of having the manually remove the foreign substances by using wet wipes or the like.

In addition, the foreign substances may generate offensive odor while being accumulated continuously, and hairs and the like are tangled on the flow path and hinder the flow of air, which may cause a loss of the flow path. In addition, the foreign substances exposed to the user's visual field may cause unpleasantness.

In order to solve the above-mentioned problems, in the cleaner station 100 according to the embodiment of the present disclosure, the door unit 140 may include the scraper 145 to remove foreign substances.

A specific description of the scraper 145 will be described below.

Meanwhile, the dust suction module 190 will be described below with reference to FIGS. 2 and 19.

The cleaner station 100 may include the dust suction module 190. The dust suction module 190 may include the dust collecting motor 191, a first filter 192, and a second filter (not illustrated).

The dust collecting motor 191 may be disposed below the dust collecting part 170. The dust collecting motor 191 may generate the suction force in the first cleaner flow path part 181 and the second cleaner flow path part 182. Therefore, the dust collecting motor 191 may provide the suction force capable of sucking the dust in the dust bin 220 of the first cleaner 200 and the dust in the second cleaner 300.

The dust collecting motor 191 may generate the suction force by means of the rotation. For example, the dust collecting motor 191 may be formed in a shape similar to a cylindrical shape.

Meanwhile, in the present embodiment, an imaginary dust collecting motor axis C may be defined by extending the rotation axis of the dust collecting motor 191.

The first filter 192 may be disposed between the dust collecting part 170 and the dust collecting motor 191. The first filter 192 may be a prefilter.

The second filter (not illustrated) may be disposed between the dust collecting motor 191 and the outer wall surface 112. The second filter (not illustrated) may be an HEPA filter.

Meanwhile, FIG. 19 is a block diagram for explaining a control configuration of the cleaner station according to the embodiment of the present disclosure.

The control configuration of the cleaner station 100 of the present disclosure will be described below with reference to FIG. 19.

The cleaner station 100 according to the embodiment of the present disclosure may further include a control unit 400 configured to control the coupling part 120, the fixing unit 130, the door unit 140, the cover opening unit 150, the dust collecting part 170, the flow path part 180, and the dust suction module 190.

The control unit 400 may include a printed circuit board and elements mounted on the printed circuit board.

When the coupling sensor 125 detects the coupling of the first cleaner 200, the coupling sensor 125 may transmit a signal indicating that the first cleaner 200 is coupled to the coupling part 120. In this case, the control unit 400 may receive the signal from the coupling sensor 125 and determine that the first cleaner 200 is coupled to the coupling part 120.

In addition, when the charging part 128 supplies power to the battery 240 of the first cleaner 200, the control unit 400 may determine that the first cleaner 200 is coupled to the coupling part 120.

When the control unit 400 determines that the first cleaner 200 is coupled to the coupling part 120, the control unit 400 may operate the fixing part motor 133 to fix the first cleaner 200.

When the fixing members 131 or the fixing part links 135 are moved to a predetermined fixing point FP1, a fixing detecting part 137 may transmit a signal indicating that the first cleaner 200 is fixed. The station control unit 400 may receive the signal, which indicates that the first cleaner 200 is fixed, from the fixing detecting part 137, and determine that the first cleaner 200 is fixed. When the station control unit 400 determines that the first cleaner 200 is fixed, the control unit 400 may stop the operation of the fixing part motor 133.

Meanwhile, when the operation of emptying the dust bin 200 is ended, the control unit 400 may rotate the fixing part motor 133 in the reverse direction to release the first cleaner 200.

When the control unit 400 determines that the first cleaner 200 is fixed to the coupling part 120, the control unit 400 may operate the door motor 142 to open the door 141 of the cleaner station 100.

When the door 141 or the door arm 143 reaches the predetermined opening position DP1, the door opening/closing detecting part 144 may transmit a signal indicating that the door 141 is opened. The control unit 400 may receive the signal, which indicates that the door 141 is opened, from the door opening/closing detecting part 137 and determine that the door 141 is opened. When the control unit 400 determines that the door 141 is opened, the control unit 400 may stop the operation of the door motor 142.

Meanwhile, when the operation of emptying the dust bin 200 is ended, the control unit 400 may rotate the door motor 142 in the reverse direction to close the door 141.

When the control unit 400 determines that the door 141 is opened, the control unit 400 may operate the cover opening motor 152 to open the discharge cover 222 of the first cleaner 200.

When the push protrusion 151 reaches a predetermined opening position CP1, the cover opening detecting part 155f may transmit a signal indicating that the discharge cover 222 is opened. The control unit 400 may receive the signal, which indicates that the discharge cover 222 is opened, from the cover opening detecting part 155f and determine that the discharge cover 222 is opened. When the control unit 400 determines that the discharge cover 222 is opened, the control unit 400 may stop the operation of the cover opening motor 152.

The control unit 400 may control the sterilization module 175. For example, the control unit 400 may operate the sterilization module 175 after the dust is captured in the dust collecting part 170 or operate the sterilization module 175 at a predetermined time interval, thereby killing viruses, microorganisms, and the like present inside or outside the dust collecting part 170.

The control unit 400 may control the flow path switching valve 183 of the flow path part 180. For example, the control unit 400 may selectively open or close the first cleaner flow path part 181 and the second cleaner flow path part 182.

The control unit 400 may operate the dust collecting motor 191 to suck the dust in the dust bin 220.

The control unit 400 may operate the display part 410 to display a dust bin emptied situation and a charged situation of the first cleaner 200 or the second cleaner 300.

Meanwhile, the cleaner station 100 according to the present disclosure may include the display part 410.

The display part 410 may be disposed on the housing 110, disposed on a separate display device, or disposed on a terminal such as a mobile phone.

The display part 410 may be configured to include at least any one of a display panel capable of outputting letters and/or figures and a speaker capable of outputting voice signals and sound. The user may easily ascertain a situation of a currently performed process, a residual time, and the like on the basis of information outputted through the display part.

Meanwhile, the cleaner station 100 according to the embodiment of the present disclosure may include the memory 430. The memory 430 may include various data for operating or driving the cleaner station 100.

Meanwhile, the cleaner station 100 according to the embodiment of the present disclosure may include an input part 440. The input part 440 generates key input data inputted by the user to control the operation of the cleaner station 100. To this end, the input part 440 may include a keypad, a dome switch, a touchpad (resistive touchpad/capacitive touchpad), and the like. In particular, in case that the touchpad defines a mutual layer structure together with the display part 410, the touchpad may be called a touch screen.

Meanwhile, the state in which the first cleaner 200 is coupled to the cleaner station 100 will be described below with reference to FIGS. 2 and 3.

In the present disclosure, the first cleaner 200 may be mounted on the outer wall surface 112 of the cleaner station 100. For example, the dust bin 220 and the battery housing 230 of the first cleaner 200 may be coupled to the coupling surface 121 of the cleaner station 100. That is, the first cleaner 200 may be mounted on the first outer wall surface 112a.

In this case, the suction motor axis a1 may be defined to be perpendicular to the first outer wall surface 112a. That is, the suction motor axis a1 may be defined in parallel with the ground surface. The suction motor axis a1 may be defined on a plane perpendicular to the ground surface. In addition, the suction motor axis a1 may be defined on the plane that perpendicularly intersects the first outer wall surface 112a.

The suction flow path through line a2 may be defined in parallel with the first outer wall surface 112a. The suction flow path through line a2 may be defined in the gravitational direction. That is, the suction flow path through line a2 may be defined to be perpendicular to the ground surface. In addition, the suction flow path through line a2 may be defined on the plane that perpendicularly intersects the first outer wall surface 112a.

The grip portion through line a3 may be defined to be inclined at a predetermined angle with respect to the first outer wall surface 112a. In addition, the grip portion through line a3 may be defined to be inclined at a predetermined angle with respect to the ground surface. The grip portion through line a3 may be defined on the plane that perpendicularly intersects the first outer wall surface 112a.

The cyclone line a4 may be defined to be perpendicular to the first outer wall surface 112a. That is, the cyclone line a4 may be defined in parallel with the ground surface. The cyclone line a4 may be defined on the plane perpendicular to the ground surface. In addition, the cyclone line a4 may be defined on the plane that perpendicularly intersects the first outer wall surface 112a.

The dust bin through line a5 may be defined to be perpendicular to the first outer wall surface 112a. That is, the dust bin through line a5 may be defined in parallel with the ground surface. The dust bin through line a5 may be defined on the plane perpendicular to the ground surface. In addition, the dust bin through line a5 may be defined on the plane that perpendicularly intersects the first outer wall surface 112a.

The dust collecting motor axis C may be defined to be perpendicular to the ground surface. The dust collecting motor axis C may be defined in parallel with at least any one of the first outer wall surface 112a, the second outer wall surface 112b, the third outer wall surface 112c, and the fourth outer wall surface 112d.

When the first cleaner 200 is coupled to the cleaner station 100, the suction motor axis a1 may intersect the longitudinal axis of the cleaner station 100. That is, the rotation axis of the suction motor 214 may intersect the longitudinal axis of the cleaner station 100.

When the first cleaner 200 is coupled to the cleaner station 100, the suction motor axis a1 may intersect the dust collecting motor axis C.

In the state in which the first cleaner 200 and the cleaner station 100 are coupled, the suction motor axis a1 may intersect the dust collecting motor axis C at a predetermined angle. For example, an included angle θ1 between the suction motor axis a1 and the dust collecting motor axis C may be 40 degrees or more and 95 degrees or less.

In this case, the included angle may mean an angle defined as the suction motor axis a1 and the dust collecting motor axis C intersect each other, that is, an included angle defined between the suction motor axis a1 and the dust collecting motor axis C.

Meanwhile, when the first cleaner 200 is coupled to the cleaner station 100, the handle 216 may be disposed to be farther from the ground surface than is the suction motor axis a1. With this configuration, when the user grasps the handle 216, the relatively heavy suction motor 214 is positioned at the lower side in the gravitational direction, and the user may couple or separate the first cleaner 200 to/from the cleaner station 100 only by simply moving the first cleaner 200 in the direction parallel to the ground surface. As a result, it is possible to provide convenience for the user.

In addition, when the first cleaner 200 is coupled to the cleaner station 100, the battery 240 may be disposed to be farther from the ground surface than is the suction motor axis a1. With this configuration, the first cleaner 200 may be stably supported on the cleaner station 100.

When the first cleaner 200 is coupled to the cleaner station 100, the suction flow path through line a2 may be defined in parallel with the dust collecting motor axis C. With this configuration, it is possible to minimize an occupied space on a horizontal plane in the state in which the first cleaner 200 is coupled to the cleaner station 100.

In this case, the coupling part 120 may be disposed between the suction flow path through line a2 and the dust collecting motor axis C. The fixing member 131 may be disposed between the suction flow path through line a2 and the dust collecting motor axis C. The cover opening unit 150 may be between the suction flow path through line a2 and the dust collecting motor axis C. With this configuration, the user may couple or separate the first cleaner 200 to/from the cleaner station 100, fix the dust bin 220, and open the dust bin 220 only by simply moving the first cleaner 200 in the direction parallel to the ground surface. As a result, it is possible to provide convenience for the user.

The grip portion through line a3 may intersect the dust collecting motor axis C at a predetermined angle. In this case, an intersection point P6 between the grip portion through line a3 and the dust collecting motor axis C may be positioned in the housing 110. This configuration is advantageous in that the user may couple the first cleaner 200 to the cleaner station 100 only by simply pushing his/her arm toward the lateral side of the cleaner station 100 in the state in which the user grasps the first cleaner 200. In addition, since the dust collecting motor 191, which is relatively heavy in weight, is accommodated in the housing 110, it is possible to prevent the cleaner station 100 from swaying even though the user strongly pushes the first cleaner 200 into the cleaner station 100.

When the first cleaner 200 is coupled to the cleaner station 100, the cyclone line a4 may intersect the longitudinal axis of the cleaner station 100. That is, the flow axis of the dust separating part 213 may intersect the longitudinal axis of the cleaner station 100. In this case, the intersection point between the flow axis of the dust separating part 213 and the longitudinal axis of the cleaner station 100 may be positioned in the housing 110, and more particularly, positioned in the flow path part 180.

When the first cleaner 200 is coupled to the cleaner station 100, the cyclone line a4 may intersect the dust collecting motor axis C. In this case, an intersection point between the cyclone line a4 and the dust collecting motor axis C may be positioned in the housing 110, and more particularly, positioned in the flow path part 180. With this configuration, the first cleaner 200 may be stably supported on the cleaner station 100 in the state in which the first cleaner 200 is coupled to the cleaner station 100, and a loss of flow path may be reduced during the operation of emptying the dust bin 220.

When the first cleaner 200 is coupled to the cleaner station 100, the dust bin through line a5 may intersect the longitudinal axis of the cleaner station 100. That is, the longitudinal axis of the dust bin 220 may intersect the longitudinal axis of the cleaner station 100. In this case, an intersection point between the longitudinal axis of the dust bin 220 and the longitudinal axis of the cleaner station 100 may be positioned in the housing 110, and more particularly, positioned in the flow path part 180.

Meanwhile, when the first cleaner 200 is coupled to the cleaner station 100, the handle 216 may be disposed to be farther from the ground surface than is the dust bin through line a5. With this configuration, when the user grasps the handle 216, the user may couple or separate the first cleaner 200 to/from the cleaner station 100 only by simply moving the first cleaner 200 in the direction parallel to the ground surface. As a result, it is possible to provide convenience for the user.

In addition, when the first cleaner 200 is coupled to the cleaner station 100, the battery 240 may be disposed to be farther from the ground surface than is the dust bin through line a5. In this configuration, because the battery 240 pushes the main body 210 of the first cleaner 200 by means of the weight of the battery 240, the first cleaner 200 may be stably supported on the cleaner station 100.

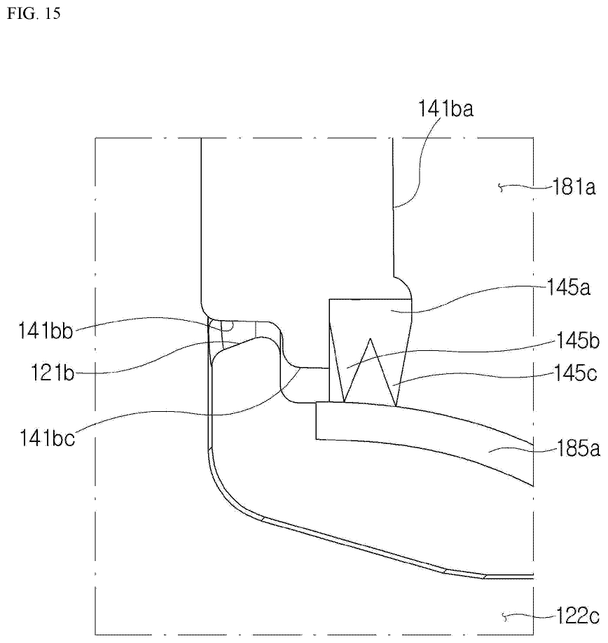

Meanwhile, FIG. 14 is a cross-sectional perspective view for explaining a state in which the door blocks the dust passage hole in the cleaner station according to the embodiment of the present disclosure, and FIG. 15 is a view of FIG. 14 when viewed at another angle.

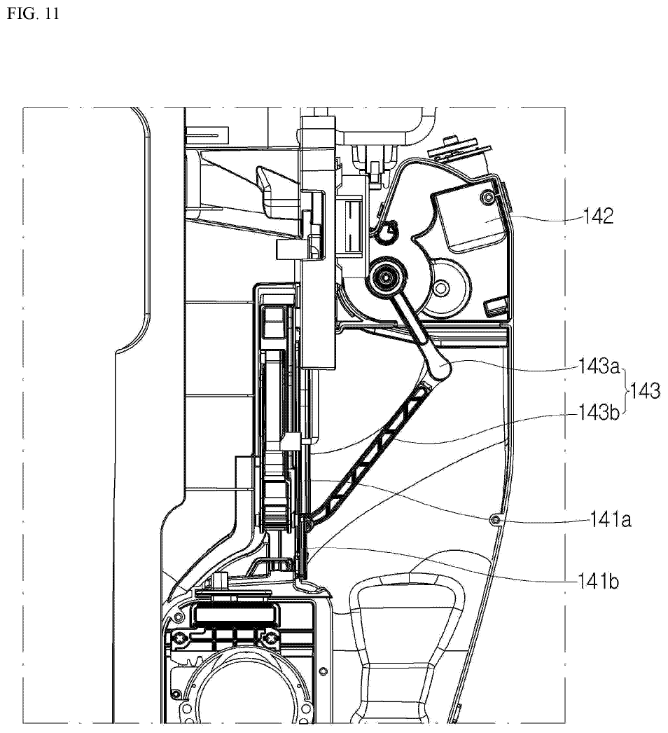

The scraper according to the embodiment of the present disclosure will be described below with reference to FIGS. 11, 12, 14, and 15.

The scraper 145 may be coupled to the second door outer wall surface 141bb and protrude radially outward from the second door outer wall surface 141bb. Therefore, in the state in which the door 141 blocks the dust passage hole 121a, the second door 141b of the door 141 may be disposed below the first door 141a, and the scraper 145 may protrude downward from the second door 141b.

In this case, a protruding length of the scraper 145 may be longer than a distance between the second door outer wall surface 141bb and the first flow path tube 185a. Therefore, the scraper 145 may come into contact with at least a part of the first flow path tube 185a in case that the door 141 is closed and the door 141 blocks the dust passage hole 121a. In addition, the scraper 145 may generate friction with the inner peripheral surface of the first flow path tube 185a.

Specifically, the scraper 145 may include a door coupling part 145a, a first scraper 145b, and a second scraper 145c.

The door coupling part 145a may be coupled to the outer peripheral surface of the door 141. Specifically, the door coupling part 145a may be formed in an arc shape and coupled to the second door outer wall surface 141bb. The first and second scrapers 145b and 145c to be described below may protrude and extend from the door coupling part 145a.

The first scraper 145b may protrude and extend radially outward from the door coupling part 145a. For example, the first scraper 145b may protrude so that a width thereof decreases as the distance from the door coupling part 145a increases. That is, the first scraper 145b may be a rib having a triangular cross-sectional shape. With this configuration, foreign substances tangled on the scraper 145 or attached to the scraper 145 by static electricity may be easily removed during a process in which the scraper 145 wipes away the foreign substances.

The second scraper 145c may protrude and extend radially outward from the door coupling part 145a. In this case, the second scraper 145c may protrude in parallel with the first scraper 145b. For example, the second scraper 145c may protrude so that a width thereof decreases as the distance from the door coupling part 145a increases. That is, the second scraper 145c may be a rib having a triangular cross-sectional shape.

Meanwhile, the scraper 145 may be made of a material having elasticity. In the present embodiment, rubber is used as the material of the scraper 145, but the present disclosure is not limited thereto. The scraper 145 may be made of various materials that may allow the scraper 145 to be elastically deformed while coming into contact with the first flow path tube 185a and generate friction between the scraper 145 and the first flow path tube 185a.

Meanwhile, in this case, the first scraper 145b may be disposed to be closer to the dust passage hole 121a than the second scraper 145c to the dust passage hole 121a. That is, the first scraper 145b may be disposed to be closer to the stopper 141bc of the second door 141b than the second scraper 145c to the stopper 141bc.

Therefore, an area in which the first scraper 145b is deformed while coming into contact with the first flow path tube 185a may be different from an area in which the second scraper 145c is deformed by the first flow path tube 185a in case that the door 141 blocks the dust passage hole 121a. For example, the first flow path tube 185a may be formed while defining a continuous surface together with the sidewall of the dust passage hole 121a. In this case, the first flow path tube 185a may be formed to be inclined downward at a predetermined angle from the dust passage hole 121a. Therefore, an area in which the first scraper 145b and the first flow path tube 185a are compressed or rub against each other while interfering with each other may be larger than an area in which the second scraper 145c and the first flow path tube 185a are compressed or rub against each other. In contrast, the stopper 141bc comes into contact with the sidewall 121b of the dust passage hole 121a, but the amount of generated frictional force is small. That is, a frictional force between the scraper 145 and the inner peripheral surface of the first flow path tube 185a may be higher than a frictional force between the stopper 141bc and the sidewall 121b of the dust passage hole 121a. With this configuration, the scraper 145 may serve as a kind of squeegee. The foreign substances, which contain hairs and remain in the dust passage hole 121a and on the inner peripheral surface of the first flow path tube 185a, may be rubbed and scraped by the scraper 145 during the process of opening or closing the door 141, such that the foreign substances may be removed.

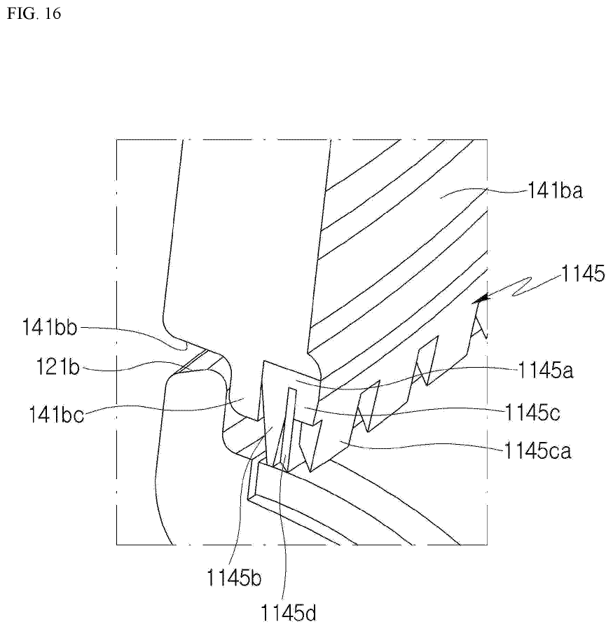

Meanwhile, FIG. 16 is a cross-sectional perspective view for explaining a state in which a door blocks a dust passage hole in a cleaner station according to a second embodiment of the present disclosure.

A scraper 1145 according to the second embodiment of the present disclosure will be described below with reference to FIGS. 11, 12, and 16.

Meanwhile, in order to avoid the repeated description, the description of the configuration and effect of the scraper 145 of the cleaner station according to the embodiment of the present disclosure may be applied to the following description, except for the components that will be particularly described in the present embodiment.

The scraper 1145 of the present embodiment may further include a blade 1145d provided between a first scraper 1145b and a second scraper 1145c.

The blade 1145d may cut foreign substances such as hairs. Specifically, a tip portion of the blade 1145d may be ground sharply to cut foreign substances such as hairs. Further, the blade 1145d may be made of a material such as metal, resin, or silicone that may form a sharp blade.

With this configuration, the foreign substances, which remain in the dust passage hole 121a and remain on the inner peripheral surface of the first flow path tube 185a may be cut by the blade 1145d. Therefore, according to the present embodiment, the foreign substances such as hairs may be prevented from being tangled. The foreign substances such as hairs may be removed by the scraper 1145 without remaining in the dust bin 220 or remaining on the sidewall 121b of the dust passage hole 121a or the inner peripheral surface of the first flow path tube 185a.

In addition, in the present embodiment, the blade 1145d may be provided between the first scraper 1145b and the second scraper 1145c, such that the blade 1145d may be elastically supported by an elastic force of the first scraper 1145b and an elastic force of the second scraper 1145c. Therefore, the blade 1145d may be prevented from excessively pressing the inner peripheral surface of the first flow path tube 185a, thereby preventing damage to the first flow path tube 185a.

Meanwhile, in the present embodiment, the second scraper 1145c may include a plurality of scraper teeth 1145ca protruding and disposed in parallel at predetermined intervals along the outer peripheral surface of the door 141. That is, in the present embodiment, the second scraper 1145c may have spaces between the plurality of scraper teeth 1145ca spaced apart from one another. With this configuration, the frictional force between the second scraper 1145c and the first flow path tube 185a may be reduced. In addition, it is possible to prevent the occurrence of interference caused by the second scraper 1145c when the blade 1145d cuts the foreign substances such as hairs.

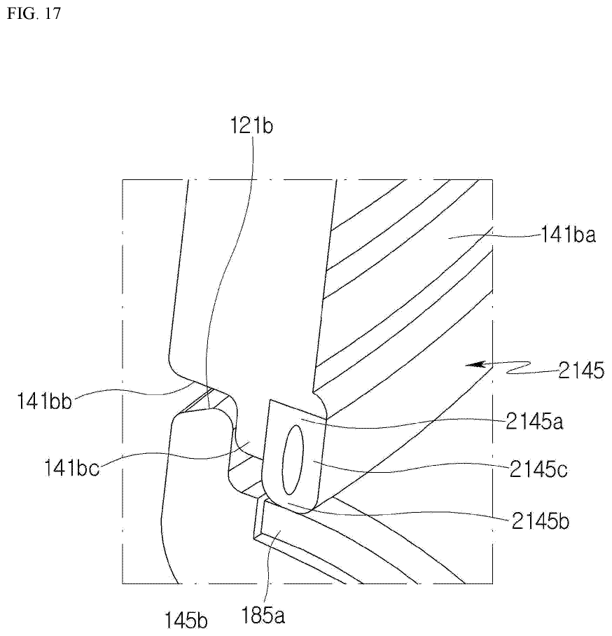

Meanwhile, FIG. 17 is a cross-sectional view for explaining a state in which a door blocks a dust passage hole in a cleaner station according to a third embodiment of the present disclosure.

A scraper 2145 according to the third embodiment of the present disclosure will be described below with reference to FIGS. 11, 12, and 17.

Meanwhile, in order to avoid the repeated description, the description of the configuration and effect of the scraper 145 of the cleaner station according to the embodiment of the present disclosure may be applied to the following description, except for the components that will be particularly described in the present embodiment.

In the present embodiment, the scraper 2145 may be a hollow gasket. Specifically, the scraper 2145 may include a door coupling part 2145a, a friction part 2145b, and a connection part 2145c.

The door coupling part 2145a may be coupled to the outer peripheral surface of the door 141. Specifically, the door coupling part 145a may be formed in an arc shape and coupled to the second door outer wall surface 141bb. The connection part 2145c may protrude and extend from the door coupling part 145a.

When the door 141 blocks the dust passage hole 121a, the friction part 2145b may rub against the flow path tube 185.

The connection part 2145c may be formed to connect the door coupling part 2145a and the friction part 2145b, and a space may be formed in the scraper 2145 surrounded by the door coupling part 2145a, the friction part 2145b, and the connection part 2145c. With this configuration, the scraper 2145 may be compressed while being compressed by coming into contact with the first flow path tube 185a, and a frictional force between the scraper 2145 and the first flow path tube 185a may be increased. Therefore, according to the present embodiment, the frictional force between the scraper 2145 and the first flow path tube 185a may be increased, such that the effect of wiping away the foreign substances and the effect of sealing the door 141 may be improved.

Meanwhile, FIG. 18 is a cross-sectional view for explaining a state in which a door blocks a dust passage hole in a cleaner station according to a fourth embodiment of the present disclosure.

A scraper 3145 according to the fourth embodiment of the present disclosure will be described below with reference to FIGS. 11, 12, and 18.

Meanwhile, in order to avoid the repeated description, the description of the configuration and effect of the scraper 145 of the cleaner station according to the embodiment of the present disclosure may be applied to the following description, except for the components that will be particularly described in the present embodiment.

In the present embodiment, the scraper 3145 may be configured to wipe away foreign substances such as hairs while rubbing against the inner peripheral surface of the first flow path tube 185a. For example, in the present embodiment, the scraper 3145 may be a brush provided along a second door outer wall surface 3141bb. For example, the brush may include bristles. As another example, the brush may be made of a felt material. With this configuration, the scraper 3145 may wipe away foreign substances toward the dust collecting part 170 when the door 141 is opened. Thereafter, when the dust collecting motor 191 operates, the foreign substances may be captured by the dust collecting part 170. Therefore, according to the present embodiment, it is possible to minimize damage caused by friction between the scraper 3145 and the first flow path tube 185a.

Meanwhile, an operation and effect of the scraper of the cleaner station according to the present disclosure will be described below.

First, when the dust bin 220 is fixed to the cleaner station 100, the door 141 of the cleaner station 100 may be opened.

Specifically, when the control unit 400 receives a signal, which indicates that the dust bin 220 is fixed, from the fixing detecting part 137, and the control unit 400 may operate the door motor 142 in the forward direction, such that the door 141 may open the dust passage hole 121a while rotating. That is, the control unit 400 may open the dust passage hole 121a by rotating the door 141.

Further, the discharge cover 222 of the dust bin 220 rotates such that the space in the dust bin main body 221 is opened, and the door 141 rotates such that the dust passage hole 121a is opened. Therefore, the internal space of the dust bin 220 may communicate with the flow path part 180 (particularly the first cleaner flow path part 181) of the cleaner station 100.

In this case, the scraper 145 may generate friction with the first flow path tube 185a while rotating together with the door 141. Further, the scraper 145 may wipe away and remove the foreign substances remaining in the dust passage hole 121a and/or remaining on the inner peripheral surface of the first flow path tube 185a. That is, the scraper 145 may wipe away the foreign substances toward the dust collecting part 170 during the process of opening the door 141.

Meanwhile, in this process, the foreign substances may be tangled on the scraper 145 or attached to the scraper 145 by static electricity.

When the dust collecting motor 191 operates in this situation, the dust in the dust bin 220 is sucked into the dust collecting part 170, such that the dust in the dust bin 220 may be removed. Further, the foreign substances remaining on the scraper 145 may also be removed by the suction force generated by the dust collecting motor 191.

Therefore, according to the present disclosure, the dust collecting motor 191 may operate in the state in which the door 141 is opened, thereby removing the foreign substances remaining in the dust passage hole 121a and/or the first flow path tube 185a and remaining on the first cleaner flow path part 181.

Meanwhile, on the contrary, the door 141 may be opened even in the state in which the dust collecting motor 191 operates. In this case, because the suction force generated by the dust collecting motor 191 is applied to the first cleaner flow path part 181, the foreign substances on the first cleaner flow path part 181 may be wiped away by the scraper 145 and simultaneously captured by the dust collecting part 170.

Meanwhile, when the door 141 closes the dust passage hole 121a, the scraper 145 may wipe away the foreign substances remaining on the inner peripheral surface of the first flow path tube 185a.

Further, the cleaner station 100 of the present disclosure may operate the dust collecting motor 191 in the state in which the door 141 blocks the dust passage hole 121a. In this case, because the dust passage hole 121a is closed, the dust is not collected in the dust bin 220. In contrast, the dust or the like remaining at the periphery of the dust bin 220 may be sucked into the dust collecting part 170 through the bypass flow path by negative pressure generated by the operation of the dust collecting motor 191. In this case, the foreign substances remaining in the first flow path tube 185a or remaining on the scraper 145 may be sucked into the dust collecting part 170.

In particular, in case that the scraper 1145 has the blade 1145d as in the second embodiment of the present disclosure, the foreign substances such as hairs may be cut by the blade 1145d during the process in which the door 141 closes the dust passage hole 121a, such that the foreign substances are prevented from being tangled or agglomerated.

Meanwhile, in the cleaner station 100 of the present disclosure, the door 141 may block the dust passage hole 121a in the situation in which the dust collecting motor 191 operates. In this case, a flow rate at which the dust collecting motor 191 sucks the dust may be constant, but a flow velocity may increase as an area of the dust passage hole 121a decreases. With the change in flow velocity, the foreign substances remaining in the dust bin 220, remaining at the periphery of the dust passage hole 121a, and remaining in the first flow path tube 185a may be captured by the dust collecting part 170.

Meanwhile, in the cleaner station 100 of the present disclosure, after the operation of the dust collecting motor 191 ends, the door 141 may rotate to open at least a part of the dust passage hole 121a and then block the dust passage hole 121a again.

This is to prevent the dust passage hole 121a from being finely opened. Therefore, the door 141 blocks the dust passage hole 121a once again after the operation of the dust collecting motor 191 ends, which may prevent a reverse flow of dust that may be present on the flow path part 180. In this case, the scraper 145 may also rotate together with the door 141, thereby wiping away and removing the foreign substances that contain hairs and remain in the dust passage hole 121a and/or the first flow path tube 185a.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A cleaner station comprising:
a housing;
a coupling part disposed in the housing and including a coupling surface to which at least a part of a cleaner is coupled;
a dust collecting part accommodated in the housing, disposed below the coupling part, and configured to capture dust in a dust bin of the cleaner;
a dust collecting motor accommodated in the housing, disposed below the dust collecting part, and configured to generate a suction force for sucking the dust in the dust bin;
a door unit including a door hingedly coupled to the coupling surface to open or close a dust passage hole formed in the coupling surface; and
a flow path part provided in a flow path tube disposed in the housing, the flow path part being configured to connect the dust bin of the cleaner and the dust collecting part,
wherein the door unit comprises a scraper coupled to the door and configured to come into contact with at least a part of the flow path tube when the door blocks the dust passage hole.

2. The cleaner station of claim 1, wherein the door comprises:
a first door hingedly coupled to the coupling surface; and
a second door hingedly coupled to the first door, and
wherein the scraper is coupled to the second door and protrudes downward from the second door.

3. The cleaner station of claim 1, wherein the door comprises:
a first door hingedly coupled to the coupling surface; and
a second door hingedly coupled to the first door,
wherein the second door comprises:
a second door main body hingedly coupled to the first door; and
a second door outer wall surface formed at an outer end of the second door main body and configured to face a sidewall of the dust passage hole when the door blocks the dust passage hole, and
wherein the scraper is coupled to the second door outer wall surface and protrudes outward from the second door outer wall surface.

4. The cleaner station of claim 1, wherein the scraper comprises:
a door coupling part coupled to an outer peripheral surface of the door;
a first scraper protruding and extending outward from the door coupling part; and
a second scraper protruding from the door coupling part in parallel with the first scraper.

5. The cleaner station of claim 1, wherein the scraper is a squeegee.

6. The cleaner station of claim 1, wherein the scraper comprises:
a door coupling part coupled to an outer peripheral surface of the door;
a friction part configured to rub against the flow path tube when the door blocks the dust passage hole; and
a connection part configured to connect the door coupling part and the friction part and define a space therein.

7. The cleaner station of claim 1, wherein the scraper is made of a felt material.

8. The cleaner station of claim 1, wherein the scraper comprises a brush.

9. The cleaner station of claim 4, wherein the scraper further comprises a blade provided between the first scraper and the second scraper.

10. The cleaner station of claim 4, wherein the second scraper comprises a plurality of scraper teeth protruding and disposed in parallel at predetermined intervals along the outer peripheral surface of the door.

11. The cleaner station of claim 1, wherein the flow path part comprises:
a first flow path configured to communicate with an internal space of the dust bin when the dust passage hole is opened; and
a second flow path formed at a predetermined angle with respect to the first flow path and configured to allow the first flow path and an internal space of the dust collecting part to communicate with each other, and
wherein the scraper comes into contact with at least a part of a first flow path tube, which constitutes the first flow path, when the door blocks the dust passage hole.

12. The cleaner station of claim 1, wherein the flow path part comprises:
a first flow path penetrated by a longitudinal axis of the dust bin in a state in which the cleaner is coupled to the cleaner station; and
a second flow path configured to communicate with the first flow path and penetrated by a longitudinal axis of the cleaner station,
wherein the longitudinal axis of the dust bin and the longitudinal axis of the cleaner station intersect each other in the state in which the cleaner is coupled to the cleaner station, and
wherein the scraper comes into contact with at least a part of a first flow path tube, which constitutes the first flow path, when the door blocks the dust passage hole.

13. A cleaner system comprising:
a cleaner including a suction part having a suction flow path through which air flows, a main body having a dust separating part having at least one cyclone part, and a dust bin configured to store dust separated by the dust separating part; and
a cleaner station including a dust collecting part configured to capture the dust in the dust bin, a dust collecting motor configured to generate a suction force for sucking the dust in the dust bin into the dust collecting part, and a housing configured to accommodate the dust collecting part and the dust collecting motor in a longitudinal direction,
wherein a longitudinal axis of the dust bin and a longitudinal axis of the cleaner station intersect each other in a state in which the cleaner is coupled to the cleaner station, and
wherein a scraper coupled to a door of the cleaner station rubs against at least a part of a flow path tube, which constitutes a flow path part, when the door of the cleaner station is closed.
